(19) United States
(12) Patent Application Publication
(10) Pub. No.: US 2024/0350982 A1
(43) Pub. Date: Oct. 24, 2024

(54) 3D PRINTED THIN FILM COMPOSITE MEMBRANES

(71) Applicants: Jeffrey R. McCutcheon, Farmington, CT (US); Mayur Ostwal, Farmington, CT (US); UNIVERSITY OF CONNECTICUT, Farmington, CT (US)

(72) Inventors: Jeffrey R. McCutcheon, Tolland, CT (US); Mayur Ostwal, Tolland, CT (US)

(21) Appl. No.: 18/701,137

(22) PCT Filed: Oct. 14, 2022
(86) PCT No.: PCT/US2022/046779

§ 371 Date: Apr. 12, 2024

Related U.S. Application Data
(60) Provisional application No. 63/255,693, filed on Oct. 14, 2021.

(51) Int. Cl. B01D 69/14; B01D 53/22; B01D 69/02; B01D 69/10; B01D 69/12; B01D 71/02; B01D 71/52; B01D 71/56; B01D 71/80; B33Y 80/00

(52) U.S. Cl. CPC B01D 69/14111; B01D 53/228; B01D 69/02; B01D 69/107; B01D 69/1216; B01D 71/028; B01D 71/52; B01D 71/56; B01D 71/80; B33Y 80/00; B01D 2256/10; B01D 2256/22; B01D 2325/04; B01D 2325/20

(57) ABSTRACT

A thin-film composite membrane may comprise a mixed-matrix membrane supported by a substrate, the mixed-matrix membrane comprising two or more sublayers. At least one of the sublayers may comprise 10 by weight (wt %) to 75 wt % filler particles and 25 wt % to 90 wt % polymer. A method of making a thin-film composite membrane may include performing an electrospraying cycle, comprising electrospraying a first solution onto a surface of a substrate, the solution comprising a first solvent and filler particles, the substrate being positioned on a support surface; electrospraying a second solution onto the surface of the substrate, the second solution comprising a second solvent and a polymer; and after electrospraying a predetermined number of cycles, removing the substrate from the support surface.

### CROSS-REFERENCE TO RELATED APPLICATION(S)

This application claims priority to U.S. Provisional Patent Application No. 63/255,693 filed on Oct. 14, 2021, the entire contents of which are incorporated herein by reference.

### GOVERNMENT INTEREST

This invention was made with government support under grant number CMMI #2001624 awarded by the National Science Foundation and the U.S. Department of Energy. The government has certain rights in the invention.

### TECHNICAL FIELD

The present disclosure relates to thin-film composite membranes and methods of making the same. More specifically, thin-film composite membranes disclosed and contemplated herein include a mixed-matrix membrane supported by a substrate. Exemplary thin-film composite membranes may be particularly suited for gas separation operations.

### INTRODUCTION

Thin-film composite membranes have emerged as a promising technology for separation applications. However, the fabrication of defect-free mixed-matrix membranes continues to be a challenge. The presence of surface defects limits the use of thin-film composite membranes in separation applications.

### SUMMARY

In one aspect, a thin-film composite membrane is disclosed. The exemplary thin-film composite may comprise a mixed-matrix membrane supported by a substrate, the mixed-matrix membrane comprising two or more sublayers. At least one of the sublayers may comprise 10 by weight (wt %) to 75 wt % filler particles and 25 wt % to 90 wt % polymer.

In another aspect, a method of making a thin-film composite membrane is disclosed. The exemplary method may include performing an electrospraying cycle, comprising electrospraying a first solution onto a surface of a substrate, the solution comprising a first solvent and filler particles, the substrate being positioned on a support surface; electrospraying a second solution onto the surface of the substrate, the second solution comprising a second solvent and a polymer; and after electrospraying a predetermined number of cycles, removing the substrate from the support surface.

In another aspect, a method of making a thin-film composite membrane is disclosed. The exemplary method may comprise performing an electrospraying cycle, comprising electrospraying a mixed solution onto a surface of a substrate, the mixed solution comprising a solvent, filler particles, and a polymer, the substrate being positioned on a support surface; and after electrospraying a predetermined number of cycles, removing the substrate from a support surface.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### BRIEF DESCRIPTION OF THE DRAWINGS

FIG. 1 schematically illustrates a side view of an exemplary thin-film composite membrane.

FIG. 2 schematically illustrates an exemplary electrospray system for preparing thin-film composite membranes.

FIG. 3 schematically illustrates an exemplary electrospray system having a single nozzle.

FIG. 4 schematically illustrates an exemplary electrospray system having two nozzles.

FIG. 5 illustrates a top plan view of an exemplary electrospray system having a single nozzle.

FIG. 6 illustrates a top plan view of an exemplary electrospray system having two nozzles.

FIG. 7 schematically illustrates the layer-by-layer assembly of mixed matrix membranes to increase the loading of filler particles.

FIG. 8 is a scanning electron microscope (SEM) image of an exemplary thin-film composite membrane fabricated from a 0.1 weight % (wt %) PIM-1 solution (5 electrospray cycles/scans).

FIG. 9 is a SEM image of an exemplary thin-film composite membrane fabricated from a 0.1 wt % PIM-1/HKUST-1 solution (5 electrospray cycles/scans).

FIG. 10 is a SEM image of an exemplary thin-film composite membrane fabricated from a 0.5 wt % PIM-1/HKUST-1 solution (5 electrospray cycles/scans).

FIG. 11 shows the energy dispersive X-ray analysis (EDX) of an exemplary thin-film composite membrane fabricated from a 0.5 wt % PIM-1/HKUST-1 solution (5 electrospray cycles/scans).

FIG. 12 is a schematic illustration of the chemical interaction between the open metal site of the HKUST-1 and the cyano (CN) group of PIM-1 in an exemplary fabricated TFC membrane.

FIG. 13 is a bar graph showing the gas transport properties of the PIM-1/HKUST-1 TFC MMM compared to neat PIM-1 TFC membrane. The CO₂ permeance in ground power units (GPU, gray) and CO₂/N₂ selectivity (black).

FIG. 14 is an ultraviolet-visible spectroscopy (UV-VIS) absorption spectra of HKUST-1-PIM-1 mixture in chloroform compared with the individual ingredients: PIM-1 and HKUST-1.

FIG. 15A is an SEM image of HKUST-1 nanoparticles at a magnification of 300 nm.

FIG. 15B is an SEM image of HKUST-1 nanoparticles at a magnification of 100 nm.

FIG. 16 shows PXRD patterns comparing exemplary thin-film composite membranes fabricated from 0.5 wt % PIM-1 and 0.5 wt % PIM-1/HKUST-1 solutions, to the simulated HKUST-1 from the single crystal structure.

FIG. 17 shows N₂ sorption isotherm of HKUST-1 nanoparticles collected at 77 K (BET=1869 m²/g).

FIG. 18 shows PXRD patterns comparing exemplary thin-film composite membranes fabricated from 0.5 wt % PIM-1 and 0.5 wt % PIM-1/HKUST-1 solutions, to the simulated HKUST-1 from the single crystal structure.

FIG. 19 is a SEM surface image of an exemplary thin-film composite membrane fabricated from a 0.1 wt % PIM-1 solution.

FIG. 20 is a SEM surface image of an exemplary thin-film composite membrane fabricated from a 0.5 wt % PIM-1 solution.

FIG. 21A is a surface SEM image of an exemplary thin-film composite membrane fabricated from a 0.5 wt % PIM-1 solution (2 electrospray cycles/scans).

FIG. 21B is a cross-sectional SEM image of an exemplary thin-film composite membrane fabricated from a 0.5 wt % PIM-1 solution (2 electrospray cycles/scans).

FIG. 22 is a cross-sectional SEM image of an exemplary thin-film composite membrane fabricated from a 0.5 wt % PIM-1 solution (5 electrospray cycles/scans).

FIG. 23 is a SEM surface image of an exemplary thin-film composite mixed-matrix membrane fabricated from a 0.5 wt % PIM-1 solution and having a thickness of 5 μm.

FIG. 24 is a SEM surface image of an exemplary thin-film composite mixed-matrix membrane fabricated from a 0.5 wt % PIM-1 solution and having a thickness of 50 μm.

FIG. 25 is a cross-sectional SEM surface image of an exemplary thin-film composite mixed-matrix membrane fabricated from a 0.5 wt % PIM-1 solution and having a thickness of 20 μm.

FIG. 26 is a cross-sectional SEM surface image of an exemplary thin-film composite mixed-matrix membrane fabricated from a 0.5 wt % PIM-1 solution and having a thickness of 10 μm.

FIG. 27 is a cross-sectional SEM surface image of an exemplary thin-film composite mixed-matrix membrane fabricated from a 0.5 wt % PIM-1 solution and having a thickness of 4 μm.

FIG. 28 schematically illustrates the assembly of a zeolitic imidazolate framework (ZIF).

FIG. 29 schematically illustrates the assembly of the exemplary metal organic framework (MOF), Hong Kong University of Science and Technology MOF (“HKUST-1”), also known as “Cu₃(BTC)₂,” which comprises 1,3,5-benzenetricarboxylate (BTC) organic ligands and copper(II) centers.

### DETAILED DESCRIPTION

Exemplary materials, methods and techniques disclosed and contemplated herein generally relate to thin-film composite membranes comprising a thin, selective layer and a support layer. Exemplary thin-film composite membranes disclosed and contemplated herein may be defect free or substantially defect free. Exemplary thin-film composite membranes disclosed and contemplated herein may avoid aggregation of filler particles. Exemplary mixed-matrix membranes disclosed and contemplated herein may be particularly suited for use in gas separation, such as, but not limited to CO₂-selective gas separation.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

### II. Exemplary Thin-Film Composite Membranes

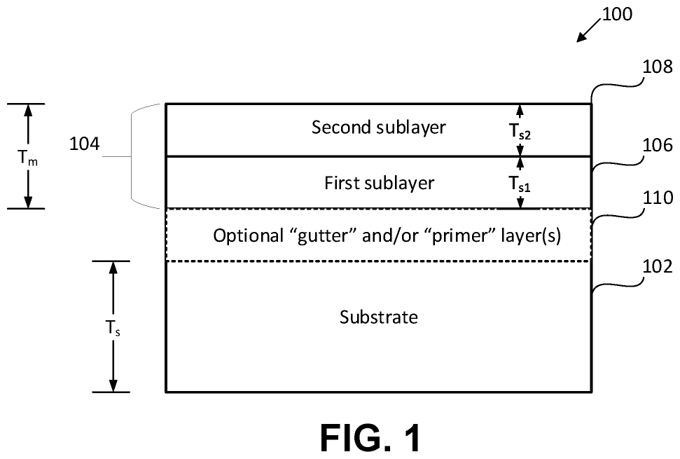

FIG. 1 schematically depicts exemplary thin-film composite membrane 100 comprising a mixed-matrix membrane 104 supported by a substrate 102. Exemplary thin-film composite membranes 100 may be defect free or substantially defect free. Defects may refer to holes or imperfections in the membrane that substantially reduce selectivity or render the membrane non-selective. A defect may be defined as a “pinhole” which is visible by the naked eye. Other defects may be smaller (on the scale of microns or hundreds of nanometer). Various aspects of exemplary mixed-matrix membranes and exemplary substrates are discussed below.

### A. Exemplary Mixed-Matrix Membranes

Exemplary mixed-matrix membranes comprise filler particles and polymer dispersed in one or more layers. Various aspects regarding mixed-matrix membrane configurations, filler particles, and polymer are discussed below.

### 1. Various Aspects of Exemplary Layers

Exemplary mixed-matrix membranes may comprise one or more layers. In some instances, exemplary mixed-matrix membranes may consist of a single layer comprising filler particles and a polymer. In other instances, the mixed-matrix membrane may comprise two or more sublayers, wherein at least one sublayer comprises filler particles and a polymer. As shown in FIG. 1, mixed-matrix membrane 104 comprises a first sublayer 106 and a second sublayer 108. Exemplary mixed-matrix membranes 104 may further comprise one or more additional first sublayers 106 and/or second sublayers 108 (not shown in FIG. 1).

In some instances, exemplary mixed-matrix membranes may comprise 2 to 50 sublayers. In some instances, exemplary mixed-matrix membranes may comprise 5 to 45 sublayers; 10 to 40 sublayers; 15 to 35 sublayers; or 20 to 30 sublayers. In some instances, exemplary mixed-matrix membranes may comprise no greater than 50 sublayers; no greater than 45 sublayers; no greater than 40 sublayers; no greater than 35 sublayers; no greater than 30 sublayers; no greater than 25 sublayers; no greater than 20 sublayers; no greater than 15 sublayers; no greater than 10 sublayers; no greater than 5 sublayers; or no greater than 2 sublayers. In some instances, exemplary mixed-matrix membranes may comprise no less than 2 sublayers; no less than 5 sublayers; no less than 10 sublayers; no less than 15 sublayers; no less than 20 sublayers; no less than 25 sublayers; no less than 30 sublayers; no less than 35 sublayers; no less than 40 sublayers; no less than 45 sublayers; or no less than 50 sublayers.

Exemplary mixed-matrix membranes may have a thickness Tₘ of 10 nm to 1000 nm. In various instances, the mixed-matrix membrane may have a thickness of 10 nm to 900 nm; 20 nm to 800 nm; 30 nm to 700 nm; 40 nm to 600 nm; 50 nm to 500 nm; 60 nm to 400 nm; 70 nm to 300 nm; 80 nm to 200 nm; or 90 nm to 100 nm. In various instances, the mixed-matrix membrane may have a thickness of no greater than 1000 nm; no greater than 900 nm; no greater than 800 nm; no greater than 700 nm; no greater than 600 nm; no greater than 500 nm; no greater than 400 nm; no greater than 300 nm; no greater than 200 nm; no greater than 100 nm; no greater than 90 nm; no greater than 80 nm; no greater than 70 nm; no greater than 60 nm; no greater than 50 nm; no greater than 40 nm; no greater than 30 nm; no greater than 20 nm; or no greater than 10 nm. In various instances, the mixed-matrix membrane may have a thickness of no less than 10 nm; no less than 20 nm; no less than 30 nm; no less than 40 nm; no less than 50 nm; no less than 60 nm; no less than 70 nm; no less than 80 nm; no less than 90 nm; no less than 100 nm; no less than 200 nm; no less than 300 nm; no less than 400 nm; no less than 500 nm; no less than 600 nm; no less than 700 nm; no less than 800 nm; no less than 900 nm; or no less than 1000 nm.

For exemplary mixed-matrix membranes comprising two or more sublayers, each sublayer may have the same composition and thickness, or, alternatively, the composition and thickness of each layer may vary.

Exemplary sublayers may have a thickness Tₛ₁ or Tₛ₂ of 1 nm to 100 nm. In various instances, exemplary sublayers may have a thickness of 5 nm to 95 nm; 10 nm to 90 nm; 15 nm to 85 nm; 20 nm to 80 nm; 25 nm to 75 nm; 30 nm to 70 nm; 35 nm to 65 nm; 40 nm to 60 nm; or 45 nm to 55 nm. In various instances, exemplary sublayers may have a thickness of no greater than 100 nm; no greater than 90 nm; no greater than 80 nm; no greater than 70 nm; no greater than 60 nm; no greater than 50 nm; no greater than 40 nm; no greater than 30 nm; no greater than 20 nm; no greater than 10 nm; or no greater than 5 nm. In various instances, exemplary sublayers may have a thickness of no less than 5 nm; no less than 10 nm; no less than 20 nm; no less than 30 nm; no less than 40 nm; no less than 50 nm; no less than 60 nm; no less than 70 nm; no less than 80 nm; no less than 90 nm; or no less than 100 nm.

In some instances, mixed-matrix membrane layers comprising two or more layers may comprise at least one polymer layer without filler particles. Exemplary polymer layers without filler particles may comprise a conductive polymer.

In some instances, exemplary mixed-matrix membranes may comprise one or more “sealing layers” to prevent leaching or shedding of the filler particles. Exemplary sealing layers may comprise polymers, such as, but not limited to, polydimethylsiloxane (PDMS). Exemplary sealing layers may have a thickness between 5 nm and 50 nm. In various instances, exemplary sealing layers may have a thickness between 10 nm and 50 nm; between 15 nm and 45 nm; between 20 nm and 40 nm; or between 25 nm and 35 nm. In various instances, exemplary sealing layers may have a thickness of no greater than 50 nm; no greater than 45 nm; no greater than 40 nm; no greater than 35 nm; no greater than 30 nm; no greater than 25 nm; no greater than 20 nm; no greater than 15 nm; no greater than 10 nm; or no greater than 5 nm. In various instances, exemplary sealing layers may have a thickness of no less than 5 nm; no less than 10 nm; no less than 15 nm; no less than 20 nm; no less than 25 nm; no less than 30 nm; no less than 40 nm; no less than 45 nm; or no less than 50 nm.

In some instances, a top layer of exemplary mixed-matrix membranes may be an “anti-fouling layer” to prevent the attachments of foulants that may reduce membrane performance. Exemplary anti-fouling layers may comprise polymers, such as, but not limited to, polyethylene glycol (PEG). Exemplary anti-fouling layers may have a thickness between 5 nm and 100 nm. In various instances, exemplary anti-fouling layers may have a thickness between 10 nm and 90 nm; between 20 nm and 80 nm; between 30 nm and 70 nm; or between 40 nm and 60 nm. In various instances, exemplary anti-fouling layers may have a thickness of no greater than 100 nm; no greater than 90 nm; no greater than 80 nm; no greater than 70 nm; no greater than 60 nm; no greater than 50 nm; no greater than 40 nm; no greater than 30 nm; no greater than 20 nm; or no greater than 10 nm. In various instances, exemplary anti-fouling layers may have a thickness of no less than 10 nm; no less than 20 nm; no less than 30 nm; no less than 40 nm; no less than 50 nm; no less than 60 nm; no less than 70 nm; no less than 80 nm; no less than 90 nm; or no less than 100 nm.

### 2. Exemplary Filler Particles

Suitable filler particles may include metal organic framework (MOF) particles, covalent organic framework (COF) particles, zeolite particles, nanotube particles, 2D material particles, silica particles, polyhedral oligomeric silsesquioxane (POSS) particles, and combinations thereof.

“Metal organic frameworks” or “MOFs” are porous crystalline materials constructed from the coordination of metal ions with organic ligands. MOFs demonstrate characteristics such as high porosity, high surface area, tunable pore structure and size, as well as versatile functionalities depending on their inorganic and organic components.

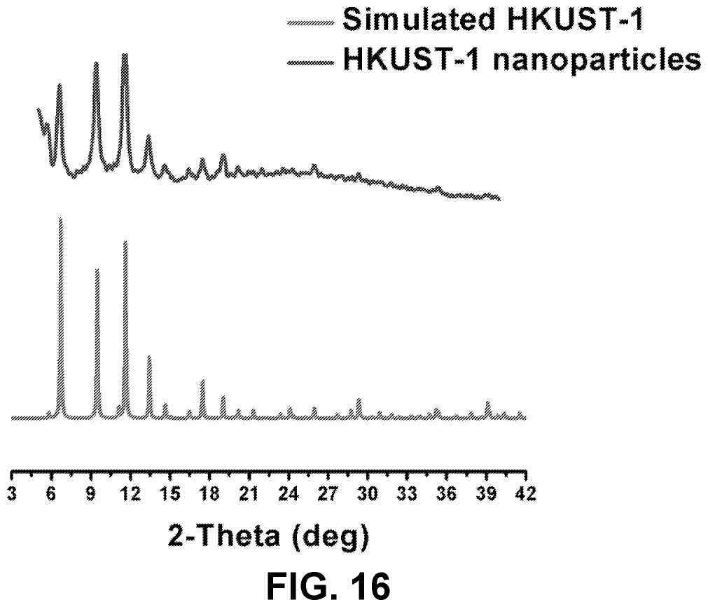

In various instances, exemplary metal organic framework (MOF) particles may comprise a zeolitic imidazolate framework, e.g., zeolitic imidazolate framework 8 (“ZIF-8”). Zeolitic imidazolate framework (ZIF) particles, such as ZIF-8 particles, are MOF particles that comprise tetrahedrally-coordinated transition metal ions (e.g., iron (Fe), cobalt (Co), copper (Cu), zinc (Zn)) connected by imidazolate linkers (e.g., Scheme 1 and FIG. 15A).

### Scheme 1. Exemplary Synthesis of ZIF-8

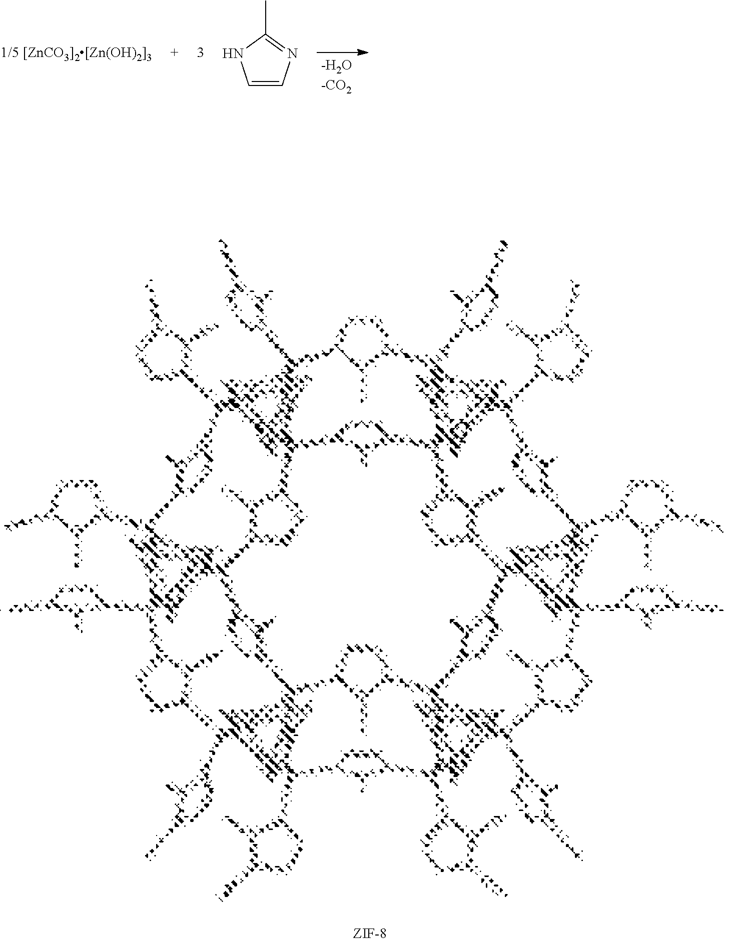

In various instances, exemplary metal organic framework (MOF) particles may comprise Cu₃(BTC)₂ (1,3,5-benzenetricarboxylate-BTC), also referred to as Hong Kong University of Science and Technology MOF (“HKUST-1”). Metal organic framework (MOF) particles comprising Cu₃(BTC)₂ are MOF particles that have a copper (Cu)-based metal-organic framework in which Cu(II) metal units are linked by benzene-1,3,5-tricarboxylate (BTC) linkers (Scheme 2 and FIG. 15B).

### Scheme 2. Exemplary Synthesis of Cu₃(BTC)₂ (i.e., HKUST-1)

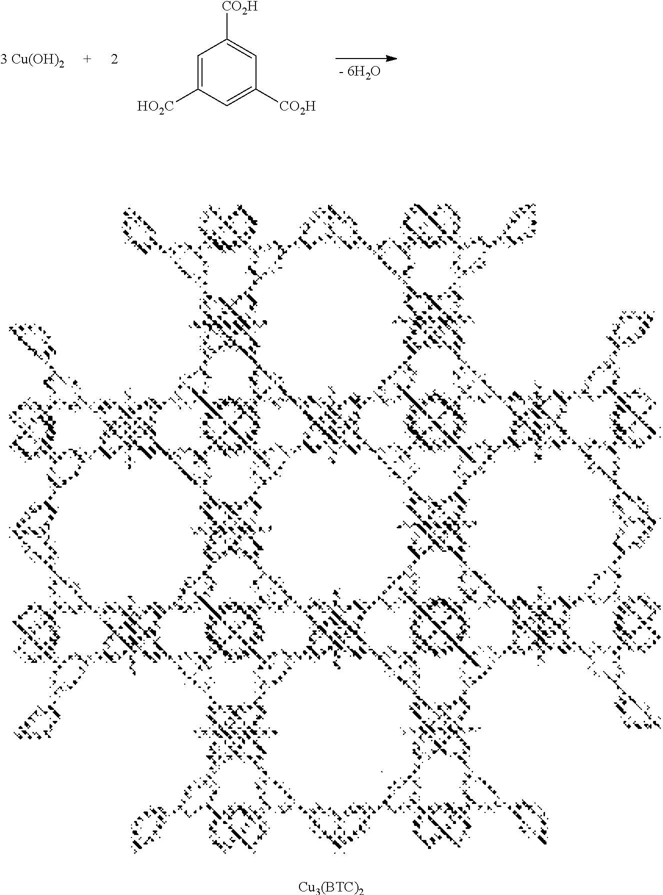 [SMILES: O=C(O)c1cc(C(=O)O)cc(C(=O)O)c1 ; "Cu3(BTC)2"]

“Covalent organic frameworks” or “COFs” are crystalline, microporous covalently linked two-and three-dimensional (2D and 3D) organic structures assembled from organic molecules.

“2D materials” are solid materials composed of a single atomic layer, or, in some instances, three atomic layers. Exemplary 2D materials include, without limitation, graphene, graphyne, transition metal dichalcogenide (TMD), phosphorene, germanane, silicene, stanene, and silicone.

“Polyhedral oligomeric silsesquioxanes” or “POSS” are stable three-dimensional organosilicon architectures containing alternate Si—O bonds to form cage structures with Si atoms as vertices. Mono- and multifunctional POSS may be prepared by modifying the Si atoms in vertex positions with one or more organic functional groups.

Exemplary mixed-matrix membranes may include at least one layer that comprises filler particles at 1% by weight (wt %) to 75 wt %. In some instances, at least one mixed-matrix membrane layer may comprise filler particles at 10% wt % to 75 wt %. In various instances, at least one mixed-matrix membrane layer may comprise filler particles at 15 wt % to 75 wt %; 15 wt % to 70 wt %; 20 wt % to 70 wt %; 20 wt % to 65 wt %; 25 wt % to 65 wt %; 25 wt % to 50 wt %; 30 wt % to 50 wt %; 30 wt % to 45 wt %; or 35 wt % to 45 wt %. In various instances, at least one mixed-matrix membrane layer may comprise filler particles at no greater than 75 wt %; no greater than 70 wt %; no greater than 65 wt %; no greater than 60 wt %; no greater than 55 wt %; no greater than 50 wt %; no greater than 45 wt %; no greater than 40 wt %; no greater than 35 wt %; no greater than 30 wt %; no greater than 25 wt %; no greater than 20 wt %; no greater than 15 wt %; or no greater than 10 wt %. In various instances, at least one mixed-matrix membrane layer may comprise filler particles at no less than 10 wt %; no less than 15 wt %; no less than 20 wt %; no less than 25 wt %; no less than 30 wt %; no less than 35 wt %; no less than 40 wt %; no less than 45 wt %; no less than 50 wt %; no less than 55 wt %; no less than 60 wt %; no less than 65 wt %; no less than 70 wt %; or no less than 75 wt %.

Exemplary filler particles may have an average diameter of 3 nm to 100 nm. In various instances, exemplary filler particles may have an average diameter of 5 nm to 95 nm; 10 nm to 90 nm; 15 nm to 85 nm; 20 nm to 80 nm; 25 nm to 75 nm; 30 nm to 70 nm; 35 nm to 65 nm; 40 nm to 60 nm; or 45 nm to 55 nm. In various instances, exemplary filler particles may have an average diameter of no greater than 100 nm; no greater than 90 nm; no greater than 80 nm; no greater than 70 nm; no greater than 60 nm; no greater than 50 nm; no greater than 40 nm; no greater than 30 nm; no greater than 20 nm; no greater than 10 nm; or no greater than 5 nm. In various instances, exemplary filler particles may have an average diameter of no less than 3 nm; no less than 5 nm; no less than 10 nm; no less than 20 nm; no less than 30 nm; no less than 40 nm; no less than 50 nm; no less than 60 nm; no less than 70 nm; no less than 80 nm; no less than 90 nm; or no less than 100 nm.

### 3. Exemplary Polymers

Exemplary polymers may comprise polyamide, polyether, polyimide, polysulfone, cellulose acetate, a thermally rearranged polymer, a ladder polymer, or a combination thereof. In various instances, the polymer may comprise a polyether block amide or a ladder polymer. A “block copolymer” or “block polymer” is a polymer containing alternating segments of different polymer compositions. A “ladder polymer” is a type of double stranded polymer with the connectivity of a ladder. In a typical one-dimensional polymer, e.g., polyethylene and polysiloxanes, the monomers form two bonds, giving a chain. In a ladder polymer the monomers are interconnected by four bonds. Exemplary ladder polymers include polymers of intrinsic microporosity (PIM), such as PIM-1, PIM-1c, sPIM-1, PIM-SBF, PIM-SBF-Me.

As used herein, “PIM-1” is a polymer of intrinsic microporosity (PIM) containing repeating units of formula:

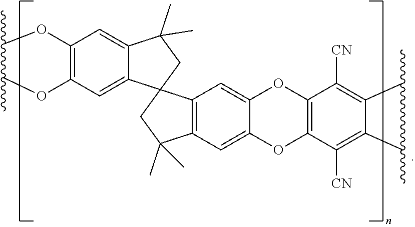

As used herein, “PIM-1c” is a polymer of intrinsic microporosity (PIM) containing repeating units of formula:

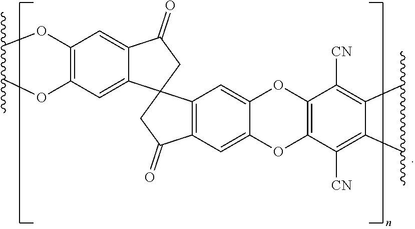

As used herein, “sPIM-1” is a polymer of intrinsic microporosity (PIM) containing repeating units of formula:

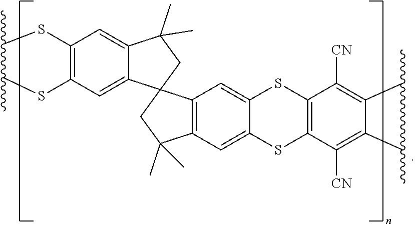

As used herein, “PIM-SBF” is a polymer of intrinsic microporosity (PIM) containing repeating units of formula:

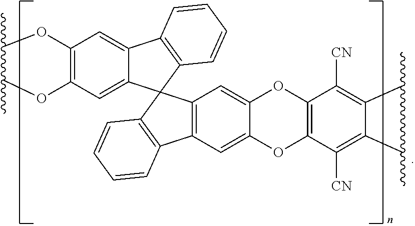

As used herein, “PIM-SBF-Me” is a polymer of intrinsic microporosity (PIM) containing repeating units of formula:

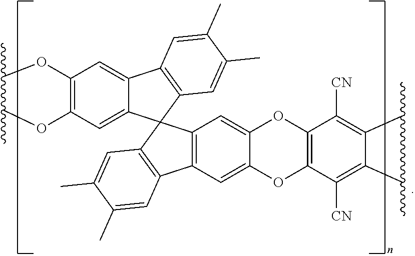

Exemplary mixed-matrix membranes may include at least one layer that comprises polymer at 25 wt % to 99 wt %. In some instances, at least one mixed-matrix membrane layer may comprise 25 wt % to 90 wt %. In various instances, at least one mixed-matrix membrane layer may comprise polymer at 25 wt % to 85 wt %; 30 wt % to 85 wt %; 30 wt % to 80 wt %; 35 wt % to 80 wt %; 35 wt % to 75 wt %; 40 wt % to 75 wt %; 40 wt % to 70 wt %; 45 wt % to 70 wt %; 45 wt % to 65 wt %; 50 wt % to 65 wt %; or 50 wt % to 60 wt %. In various instances, at least one mixed-matrix membrane layer may comprise polymer at no greater than 90 wt %; no greater than 85 wt %; no greater than 80 wt %; no greater than 75 wt %; no greater than 70 wt %; no greater than 65 wt %; no greater than 60 wt %; no greater than 55 wt %; no greater than 50 wt %; no greater than 45 wt %; no greater than 40 wt %; no greater than 35 wt %; no greater than 30 wt %; or no greater than 25 wt %. In various instances, at least one mixed-matrix membrane layer may comprise polymer at no less than 25 wt %; no less than 30 wt %; no less than 35 wt %; no less than 40 wt %; no less than 45 wt %; no less than 50 wt %; no less than 55 wt %; no less than 60 wt %; no less than 65 wt %; no less than 70 wt %; no less than 75 wt %; no less than 80 wt %; or no less than 90 wt %.

### B. Exemplary Substrates

Exemplary substrates 102 may comprise an organic or inorganic polymer material that is porous or otherwise permeable to a penetrating species. Exemplary substrate materials may be porous or non-porous and they may be isotropic (i.e., symmetric) or anisotropic (i.e., asymmetric). Exemplary substrates may be comprised of a rigid ceramic or metal material, also generally porous, which may also be isotropic or anisotropic.

In various instances, the substrate is a porous substrate. Exemplary porous substrates may comprise polysulfone, polyethersulfone, polyimide, polyetherimide, polyacrylonitrile, cellulose ester, polypropylene, polyvinyl chloride, polyvinylidene fluoride, poly (arylether) ketones, alumina, silica, zirconia, titania, carbon, steel, and combinations thereof. In various instances, a porous substrate may comprise a polyimide, a polyamideimide, a polyethersulfone, a polyacrylate, a polyphenylenesulfide, polyacrylonitrile, or a combination thereof. In various instances, the porous substrate may comprise polyacrylonitrile.

Exemplary substrates may have a thickness Tₛ of 20 μm to 200 μm. In various instances, the substrate may have a thickness of 20 μm to 180 μm; 25 μm to 175 μm; 30 μm to 170 μm; 35 μm to 165 μm; 40 μm to 160 μm; 45 μm to 155 μm; 50 μm to 150 μm; 55 μm to 145 μm; 60 μm to 140 μm; 65 μm to 135 μm; 70 μm to 130 μm; 75 μm to 125 μm; 80 μm to 120 μm; 85 μm to 115 μm; or 90 μm to 110 μm. In various instances, the substrate may have a thickness of no greater than 200 μm; no greater than 175 μm; no greater than 150 μm; no greater than 125 μm; no greater than 100 μm; no greater than 75 μm; no greater than 50 μm; no greater than 25 μm; or no greater than 20 μm. In various instances, the substrate may have a thickness of no less than 20 μm; no less than 25 μm; no less than 50 μm; no less than 75 μm; no less than 100 μm; no less than 125 μm; no less than 150 μm; no less than 175 μm; or no less than 200 μm.

### C. Exemplary Properties of Thin-Film Composite Membranes

Exemplary thin-film composite membranes may have a CO₂ permeance of 100 gas permeation units (GPU) to 2000 GPU. In various instances, exemplary thin-film composite membranes may have a CO₂ permeance of 100 GPU to 1900 GPU; 150 GPU to 1850 GPU; 200 GPU to 1800 GPU; 250 GPU to 1750 GPU; 300 GPU to 1700 GPU; 350 GPU to 1650 GPU; 400 GPU to 1600 GPU; 450 GPU to 1550 GPU; 500 GPU to 1500 GPU; 550 GPU to 1450 GPU; 600 GPU to 1400 GPU; 650 GPU to 1350 GPU; 700 GPU to 1300 GPU; 750 GPU to 1250 GPU; 800 GPU to 1200 GPU; 850 GPU to 1150 GPU; 900 GPU to 1100 GPU; or 950 GPU to 1050 GPU. In various instances, exemplary thin-film composite membranes may have a CO₂ permeance of no greater than 2000 GPU; no greater than 1900 GPU; no greater than 1800 GPU; no greater than 1700 GPU; no greater than 1600 GPU; no greater than 1500 GPU; no greater than 1400 GPU; no greater than 1300 GPU; no greater than 1200 GPU; no greater than 1100 GPU; no greater than 1000 GPU; no greater than 900 GPU; no greater than 800 GPU; no greater than 700 GPU; no greater than 600 GPU; no greater than 500 GPU; no greater than 400 GPU; no greater than 300 GPU; no greater than 200 GPU; or no greater than 100 GPU. In various instances, exemplary thin-film composite membranes may have a CO₂ permeance of no less than 100 GPU; no less than 200 GPU; no less than 300 GPU; no less than 400 GPU; no less than 500 GPU; no less than 600 GPU; no less than 700 GPU; no less than 800 GPU; no less than 900 GPU; no less than 1000 GPU; no less than 1100 GPU; no less than 1200 GPU; no less than 1300 GPU; no less than 1400 GPU; no less than 1500 GPU; no less than 1600 GPU; no less than 1700 GPU; no less than 1800 GPU; no less than 1900 GPU; or no less than 2000 GPU.

Exemplary thin-film composite membranes may have a CO₂/N₂ selectivity of 2 to 50. In various instances, exemplary thin-film composite membranes may have a CO₂/N₂ selectivity of 5 to 50; 10 to 50; 15 to 45; 20 to 45; 25 to 45; 30 to 40; or 35 to 40. In various instances, exemplary thin-film composite membranes may have a CO₂/N₂ selectivity of no greater than 50; no greater than 45; no greater than 40; no greater than 35; no greater than 30; no greater than 25; no greater than 20; no greater than 15; no greater than 10; no greater than 5; or no greater than 2. In various instances, exemplary thin-film composite membranes may have a CO₂/N₂ selectivity of no less than 2; no less than 5; no less than 10; no less than 15; no less than 20; no less than 25; no less than 30; no less than 35; no less than 40; no less than 45; or no less than 50.

### D. Exemplary Articles Comprising Thin-Film Composite Membranes

Exemplary thin-film composite membranes comprising a mixed-matrix membrane may be incorporated into a filter, such as a gas filter. Exemplary gas filters may be used to separate gases from a gas mixture. The gas mixture may include one or more chemical species in a gas/vapor phase. The gas mixture may include natural gas, syngas, flue gas, etc. In various instances, the gas mixture includes one or more of H₂, CO₂, CH₄, O₂, N₂, H₂O, He, and one or more other chemical species. In some instances, the gas mixture includes at least CO₂ and N₂.

### III. Exemplary Systems

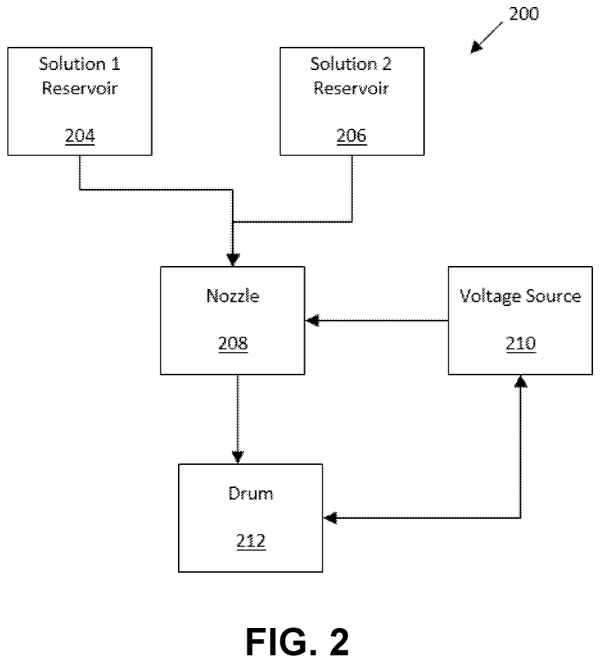

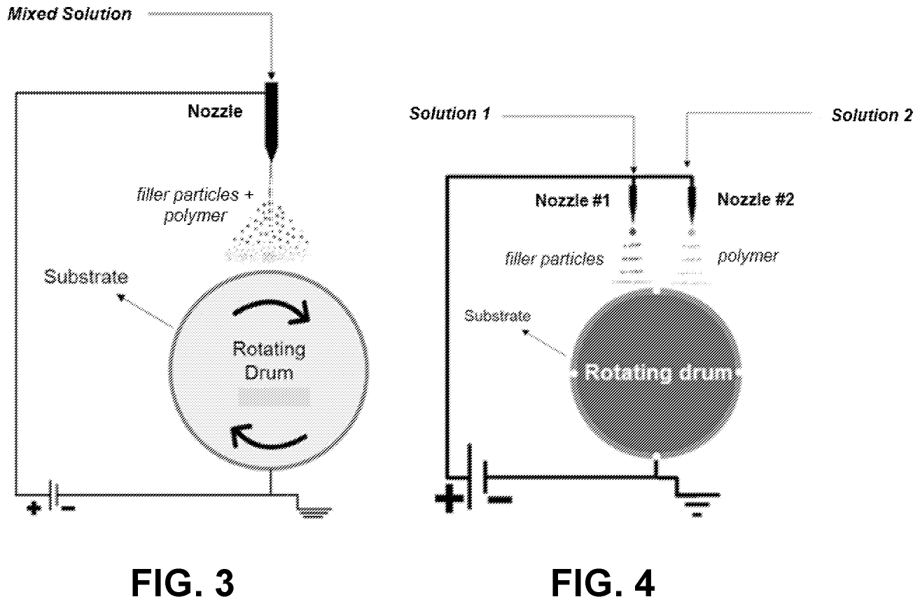

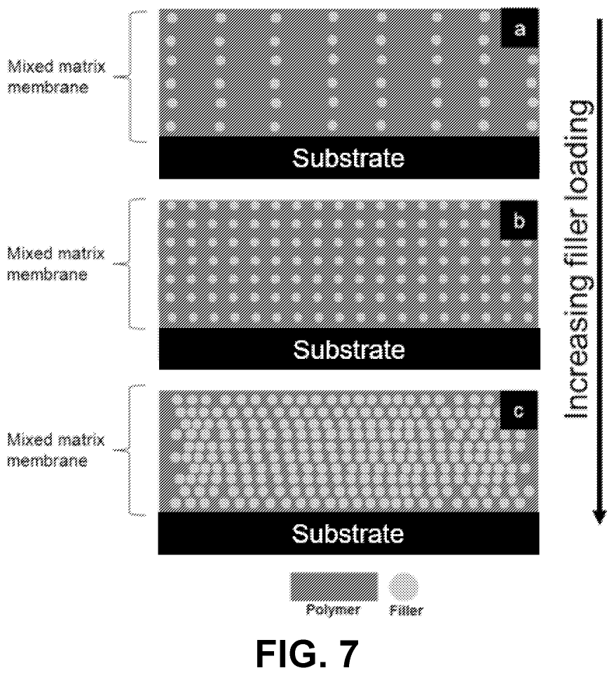

Various systems may be used to manufacture exemplary thin-film composite membranes. FIG. 2 is a schematic depiction of exemplary electrospray system 200. As shown in FIG. 2, electrospray system 200 comprises a reservoir for a first solution 204, a reservoir for a second solution 206, a nozzle 208, a voltage source 210, and a drum 212. In various instances, drum 212 may be a rotating drum. FIG. 3 is a schematic depiction of exemplary electrospray system 200. FIG. 5 is a top plan view of a portion of exemplary electrospray system 200. Unless otherwise noted, FIG. 2, FIG. 3, and FIG. 5 are discussed concurrently below.

Reservoirs 204 and 206 may retain solutions for application by nozzle 208. In some instances, reservoir 204 comprises a first solution, and reservoir 206 comprises a second solution, as described in detail above. In other instances, reservoir 204 and/or reservoir 206 comprise a mixed solution, as described in detail above.

In some instances, reservoir 204 and/or reservoir 206 comprise an agitation apparatus for mixing the solution. For example, reservoir 204 and/or reservoir 206 may comprise a stir bar or various types of agitators such as propeller agitators and paddle agitators. One or more apparatus (such as a pump) may be connected to reservoir 204, reservoir 206, and nozzle 208 to selectively provide solution 1 and/or solution 2 to nozzle 208.

Nozzle 208 is configured to spray solutions onto drum 212. Nozzle 208 is in fluid communication with solution reservoir 204 and solution reservoir 206. In some instances, a reservoir may comprise a single mixed solution comprising filler particles and polymer in a solvent (not shown).

Nozzle 208 may also be in electrical communication with voltage source 210. Various mechanical and electrical components, not shown, may be in communication with nozzle 208 to move the nozzle across the substrate.

Voltage source 210 may be in electrical communication with nozzle 208 and provide applied voltage to ionize and spray solutions from nozzle 208 to drum 212. Voltage source 210 may also be in electrical communication with drum 212 to generate a potential difference between nozzle 208 and drum 212.

Drum 212 supports a substrate during electrospraying operations. During electrospraying operations, the substrate may be positioned on a support surface of drum 212. In various instances, drum 212 may have various shapes. As an example, drum 212 may be cylindrical. Exemplary drums may comprise a substrate, e.g., a porous substrate.

Various distances between drum 212 and nozzle 208 may be used. For instance, a distance of 2 cm to 8 cm; 2 cm to 5 cm; 5 cm to 8 cm; 3 cm to 7 cm; 4 cm to 6 cm; or 4 cm to 8 cm between drum 212 and nozzle 208 may be used.

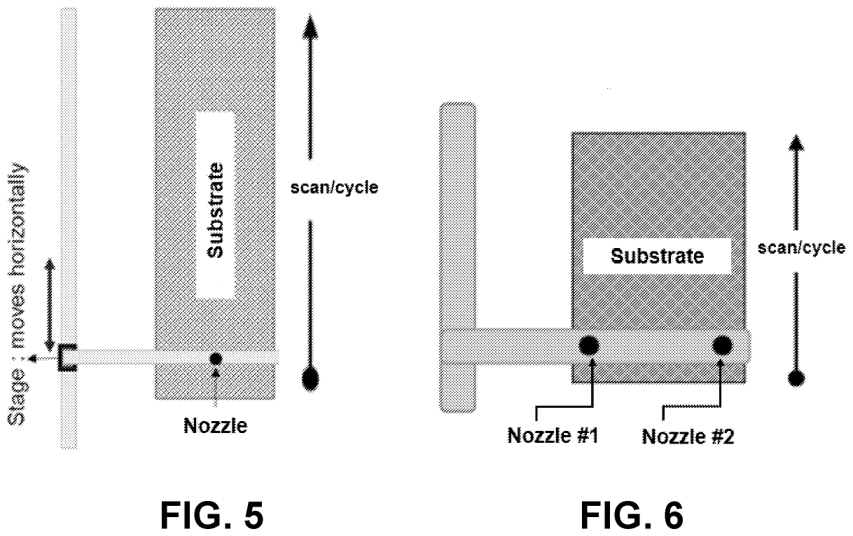

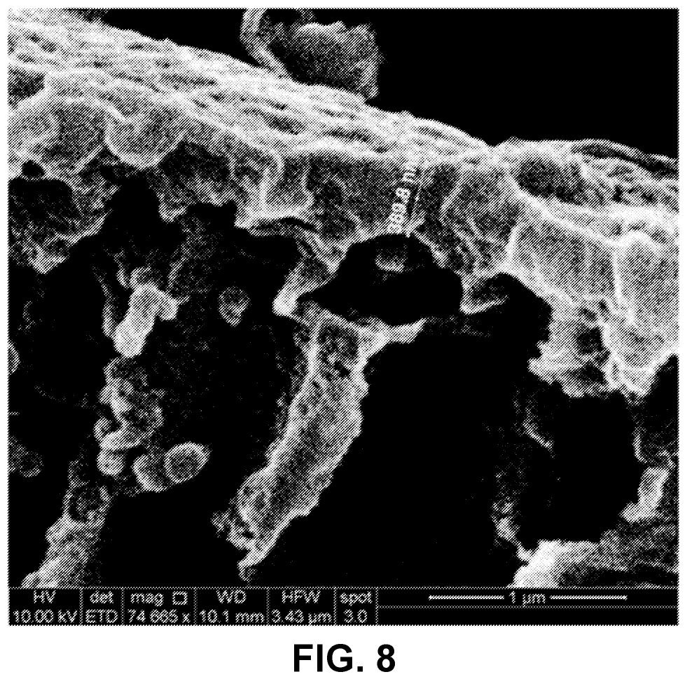

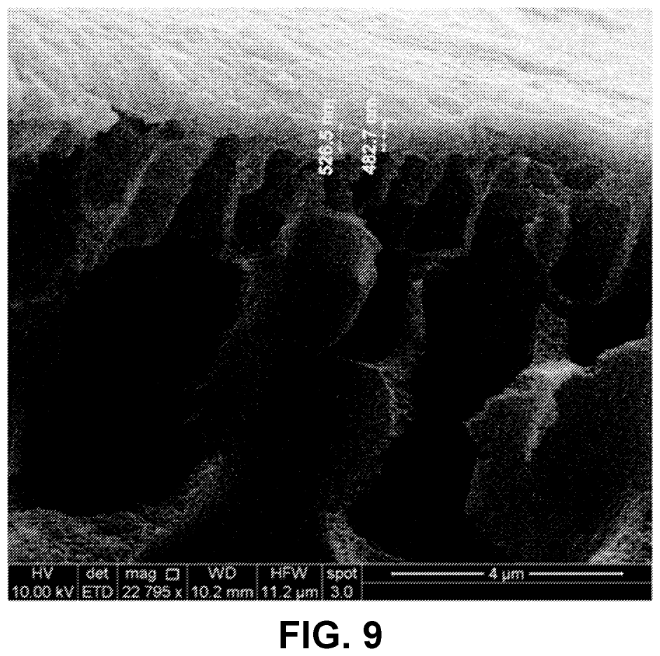

FIG. 4 is a schematic view of an alternative embodiment of system 200. FIG. 6 is a top plan view of the system shown in FIG. 4, and is discussed concurrently. As shown, system 200 comprises a first nozzle and a second nozzle. The first nozzle is in fluid communication with reservoir 204 and selectively applies a solution comprising filler particles to the substrate. The second nozzle is in fluid communication with reservoir 206 and selectively applies a solution comprising polymer to the substrate.

### IV. Exemplary Methods of Manufacture

Broadly, exemplary methods for making thin-film composite membranes may comprise pre-electrospraying operations, electrospraying operations, and post-electrospraying operations. Various aspects of exemplary methods are described below.

### A. Pre-Electrospraying Operations

Before exemplary electrospraying operations, pre-electrospraying operations may be optionally performed to modify a substrate. Modifying the substrate may comprise chemical oxidation, plasma oxidation, ultraviolet (UV) oxidation, atomic layer deposition (ALD), chemical vapor deposition (CVD), inorganic coating, or polymer coating operations, including, but not limited to, dip coating, spray coating, or in-situ polymerization.

As mentioned above, FIG. 1 depicts an exemplary thin-film composite membrane 100. As shown, thin-film composite membrane 100 has an optional gutter layer and/or primer layer 110 between the substrate 102 and the mixed-matrix membrane 104.

In some instances, a low-density polymer layer, referred to as a “gutter layer,” 110 may be deposited on the substrate prior to the deposition of the mixed-matrix membrane. A gutter layer may increase a thin film composite membrane's permeance and/or may prevent pore penetration in the mixed-matrix membrane. Exemplary gutter layers and materials may be used as described in M. Kattula, et al., “Designing ultrathin film composite membranes: the impact of a gutter layer,” Scientific Reports, 5, Article Number 15016 (2015), pp. 1-9, the entire contents of which is hereby incorporated by reference.

When used, exemplary gutter layers may have a thickness between 10 nm and 100 nm. In various instances, exemplary gutter layers may have a thickness between 10 nm and 90 nm; between 20 nm and 80 nm; between 30 nm and 70 nm; or between 40 nm and 60 nm. In various instances, exemplary gutter layers may have a thickness of no greater than 100 nm; no greater than 90 nm; no greater than 80 nm; no greater than 70 nm; no greater than 60 nm; no greater than 50 nm; no greater than 40 nm; no greater than 30 nm; no greater than 20 nm; or no greater than 10 nm. In various instances, exemplary gutter layers may have a thickness of no less than 10 nm; no less than 20 nm; no less than 30 nm; no less than 40 nm; no less than 50 nm; no less than 60 nm; no less than 70 nm; no less than 80 nm; no less than 90 nm; or no less than 100 nm.

In some instances, a “primer layer” 110 may be deposited on the substrate prior to the deposition of a mixed-matrix membrane. Exemplary primer layers may improve adhesion of the mixed-matrix membrane to the substrate. Exemplary primer layers may comprise resins, including, without limitation, urethane resins, epoxy resins, and combinations thereof.

Exemplary primer layers may have a thickness between 1 nm and 10 nm. In various instances, exemplary primer layers may have a thickness between 1 nm and 9 nm; between 2 nm and 8 nm; between 3 nm and 7 nm; or between 4 nm and 6 nm. In various instances, exemplary primer layers may have a thickness of no greater than 10 nm; no greater than 9 nm; no greater than 8 nm; no greater than 7 nm; no greater than 6 nm; no greater than 5 nm; no greater than 4 nm; no greater than 3 nm; no greater than 2 nm; or no greater than 1 nm. In various instances, exemplary primer layers may have a thickness of no less than 1 nm; no less than 2 nm; no less than 3 nm; no less than 4 nm; no less than 5 nm; no less than 6 nm; no less than 7 nm; no less than 8 nm; no less than 9 nm; or no less than 10 nm.

### B. Exemplary Electrospraying Operations

Exemplary methods of making thin-film composite membranes may comprise performing an electrospraying cycle. In various instances, exemplary methods may comprise a plurality of electrospraying cycles. The number of electrospraying cycles may be predetermined. Various aspects of exemplary electrospraying cycles are described below.

### 1. Exemplary Electrospraying Operation Parameters

As shown in FIG. 2, for exemplary electrospraying methods, a voltage source (e.g., voltage source 210) may be used to generate an electric field between a nozzle (e.g., 208) and a surface (e.g., drum 212). In various instances, the voltage source may be a high voltage DC power source. In various instances, the applied voltage may be 1 kV to 30 kV. In various instances, the applied voltage may be 1 kV to 29 kV; 2 kV to 28 kV; 3 kV to 27 kV; 4 kV to 26 kV; 5 kV to 25 kV; 6 kV to 24 kV; 7 kV to 23 kV; 8 kV to 22 kV; 9 V to 21 kV; 10 kV to 20 kV; 11 kV to 19 kV; 12 kV to 18 kV; 13 kV to 17 kV; or 14 kV to 16 kV. In various instances, the applied voltage may be no greater than 30 kV; no greater than 25 kV; no greater than 20 kV; no greater than 15 kV; no greater than 10 kV; no greater than 5 kV; or no greater than 1 kV. In various instances, the applied voltage may be no less than 1 kV; no less than 5 kV; no less than 10 kV; no less than 15 kV; no less than 20 kV; no less than 25 kV; or no less than 30 kV.

Exemplary methods may comprise electrospraying a solution as a stable spray from the nozzle. As used herein “a stable spray,” refers to a cone-jet mode (characterized by a conical meniscus (Taylor cone), from whose apex a steady jet emission is formed) where the solution is elongated into a long, fine jet of droplets which deposit onto the substrate surface without intermittency.

Exemplary electrospraying methods may comprise a flow rate of the solution through the nozzle of 0.1 mL/hour to 20 mL/hour. In various instances, the flow rate of the solution through the nozzle may be 0.5 mL/hour to 20 mL/hour; 1 mL/hour to 19 mL/hour; 2 mL/hour to 18 mL/hour; 3 mL/hour to 17 mL/hour; 4 mL/hour to 16 mL/hour; 5 mL/hour to 15 mL/hour; 6 mL/hour to 14 mL/hour; 7 mL/hour to 13 mL/hour; 8 mL/hour to 12 mL/hour; or 9 mL/hour to 11 mL/hour. In various instances, the flow rate of the solution through the nozzle may be no greater than 20 mL/hour; no greater than 15 mL/hour; no greater than 10 mL/hour; no greater than 5 mL/hour; no greater than 1 mL/hour; no greater than 0.5 mL/hour; or no greater than 0.1 mL/hour. In various instances, the flow rate of the solution through the nozzle may be no less than 0.1 mL/hour; no less than 0.5 mL/hour; no less than 1 mL/hour; no less than 5 mL/hour; no less than 10 mL/hour; no less than 15 mL/hour; or no less than 20 mL/hour.

Exemplary electrospray droplets may have a diameter of 0.01 μm to 1.00 μm. In various instances, exemplary droplets may have a diameter of 0.05 μm to 0.95 μm; 0.10 μm to 0.90 μm; 0.15 μm to 0.85 μm; 0.20 μm to 0.80 μm; 0.25 μm to 0.75 μm; 0.30 μm to 0.70 μm; 0.35 μm to 0.65 μm; 0.40 μm to 0.60 μm; or 0.45 μm to 0.55 μm. In various instances, exemplary droplets may have a diameter of no greater than 1.00 μm; no greater than 0.90 μm; no greater than 0.80 μm; no greater than 0.70 μm; no greater than 0.60 μm; no greater than 0.50 μm; no greater than 0.40 μm; no greater than 0.30 μm; no greater than 0.20 μm; no greater than 0.10 μm; or no greater than 0.01 μm. In various instances, exemplary droplets may have a diameter of no less than 0.01 μm; no less than 0.10 μm; no less than 0.20 μm; no less than 0.30 μm; no less than 0.40 μm; no less than 0.50 μm; no less than 0.60 μm; no less than 0.70 μm; no less than 0.80 μm; no less than 0.90 μm; or no less than 1.00 μm.

In various instances, electrospraying methods may occur at a temperature of 20° C. to 40° C. In various instances, electrospraying methods may occur at a temperature of 21° C. to 39° C.; 22° C. to 38° C.; 23° C. to 37° C.; 24° C. to 36° C.; 25° C. to 35° C.; 27° C. to 33° C.; 28° C. to 32° C.; or 29° C. to 31° C. In various instances, electrospraying methods may occur at a temperature of no greater than 40° C.; no greater than 35° C.; no greater than 30° C.; no greater than 25° C.; or no greater than 20° C. In various instances, electrospraying methods may occur at a temperature of no less than 20° C.; no less than 25° C.; no less than 30° C.; no less than 35° C.; or no less than 40° C.

As shown in FIG. 2, FIG. 3, and FIG. 5, an exemplary electrospraying cycle (i.e., scan) may comprise electrospraying one or more solutions from a nozzle, wherein the nozzle moves across the substrate, as the drum rotates. The substrate is positioned on a support surface of the drum.

As used herein a single electrospray “scan” or “cycle” refers to a single sweep of spray from the electrospray nozzle over the substrate surface. Each scan/cycle forms a discrete membrane layer; thus, the number of scans or cycles controls the thickness of the membrane.

Various rotational speeds of the drum may be used during exemplary electrospraying operations. For instance, the drum may be rotated at a speed between 10 rotations per minute (rpm) and 30 rpm. In various instances, the drum may be rotated at a speed between 10 rpm and 25 rpm; between 15 rpm and 30 rpm; between 15 rpm and 25 rpm; between 10 rpm and 20 rpm; between 12 rpm and 18 rpm; or between 17 rpm and 23 rpm. In various instances, the drum may be rotated at a speed no less than 10 rpm; no less than 13 rpm; no less than 15 rpm; no less than 18 rpm; no less than 20 rpm; or no less than 25 rpm. In various instances, the drum may be rotated at a speed no greater than 30 rpm; no greater than 25 rpm; no greater than 20 rpm; no greater than 15 rpm; or no greater than 12 rpm.

Exemplary methods may comprise 2 to 50 electrospraying cycles thereby forming 2 to 50 membrane layers. In various instances, exemplary methods may comprise 5 to 45; 10 to 40; 15 to 35; or 20 to 30 electrospraying cycles, thereby forming 5 to 45; 10 to 40; 15 to 35; or 20 to 30 membrane layers. In various instances, exemplary methods may comprise no greater than 50; no greater than 45; no greater than 40; no greater than 35; no greater than 30; no greater than 25; no greater than 20; no greater than 15; no greater than 10; no greater than 5; or no greater than 2 electrospraying cycles, thereby forming no greater than 50; no greater than 45; no greater than 40; no greater than 35; no greater than 30; no greater than 25; no greater than 20; no greater than 15; no greater than 10; no greater than 5; or no greater than 2 membrane layers. In various instances, exemplary methods may comprise no less than 2; no less than 5; no less than 10; no less than 15; no less than 20; no less than 25; no less than 30; no less than 35; no less than 40; no less than 45; or no less than 50 electrospraying cycles, thereby forming no less than 2; no less than 5; no less than 10; no less than 15; no less than 20; no less than 25; no less than 30; no less than 35; no less than 40; no less than 45; or no less than 50 membrane layers.

### 2. Exemplary Sequential Electrospraying Operations

In some instances, to deposit filler particles and polymer sequentially, exemplary electrospraying cycles may comprise electrospraying a first solution onto a surface of a substrate and electrospraying a second solution onto the surface of the substrate. As shown in FIG. 2, in various instances, exemplary electrospraying cycles may comprise electrospraying the first solution and the second solutions from a single nozzle. Alternatively, as shown in FIG. 4 and FIG. 6, in various instances, exemplary electrospraying cycles may comprise electrospraying the first solution from a first nozzle and electrospraying the second solution from a second nozzle.

Exemplary first solutions may comprise a first solvent and filler particles. Suitable first solvents include without limitation, water, methanol, ethanol, propanol, butanol, isopropanol, ethyl acetate, diethyl ether, acetone, chloroform, acetic acid, cyclohexane, hexane, toluene, N-methyl-2 pyrrolidinone, tetrahydrofuran, triethyl amine, trimethyl amine, dimethyl sulfoxide, dimethyl formamide, and combinations thereof.

In various instances, the first solution may comprise 1 wt % to 20 wt % filler particles. In various instances, the first solution may comprise filler particles at 1 wt % to 19 wt %; 2 wt % to 18 wt %; 3 wt % to 17 wt %; 4 wt % to 16 wt %; 5 wt % to 15 wt %; 6 wt % to 14 wt %; 7 wt % to 13 wt %; 8 wt % to 12 wt %; or 9 wt % to 11 wt %. In various instances, the first solution may comprise filler particles at no greater than 20 wt %; no greater than 19 wt %; no greater than 18 wt %; no greater than 17 wt %; no greater than 16 wt %; no greater than 15 wt %; no greater than 14 wt %; no greater than 13 wt %; no greater than 12 wt %; no greater than 11 wt %; no greater than 10 wt %; no greater than 9 wt %; no greater than 8 wt %; no greater than 7 wt %; no greater than 6 wt %; no greater than 5 wt %; no greater than 4 wt %; no greater than 3 wt %; no greater than 2 wt %; or no greater than 1 wt %. In various instances, the first solution may comprise filler particles at no less than 1 wt %; no less than 2 wt %; no less than 3 wt %; no less than 4 wt %; no less than 5 wt %; no less than 6 wt %; no less than 7 wt %; no less than 8 wt %; no less than 9 wt %; no less than 10 wt %; no less than 11 wt %; no less than 12 wt %; no less than 13 wt %; no less than 14 wt %; no less than 15 wt %; no less than 16 wt %; no less than 17 wt %; no less than 18 wt %; no less than 19 wt %; or no less than 20 wt %.

Exemplary second solutions may comprise a second solvent and a polymer. Suitable second solvents include without limitation, water, methanol, ethanol, propanol, butanol, isopropanol, ethyl acetate, diethyl ether, acetone, chloroform, acetic acid, cyclohexane, hexane, toluene, N-methyl-2 pyrrolidinone, tetrahydrofuran, triethyl amine, trimethyl amine, dimethyl sulfoxide, dimethyl formamide, and combinations thereof.

In various instances, the second solution comprises 0.001 wt % to 5 wt % polymer. In various instances, the second solution may comprise polymer at 0.005 wt % to 5.0 wt %; 0.01 wt % to 4.99 wt %; 0.05 wt % to 4.95 wt %; 0.1 wt % to 4.9 wt %; 0.2 wt % to 4.8 wt %; 0.3 wt % to 4.7 wt %; 0.4 wt % to 4.6 wt %; 0. 5 wt % to 4.5 wt %; 0.6 wt % to 4.4 wt %; 0.7 wt % to 4.3 wt %; 0.8 wt % to 4.2 wt %; 0.9 wt % to 4.1 wt %; 1.0 wt % to 4.0 wt %; 1.5 wt % to 3.5 wt %; or 2.0 wt % to 3.0 wt %. In various instances, the second solution may comprise polymer at no greater than 5.0 wt %; no greater than 4.99 wt %; no greater than 4.9 wt %; no greater than 4.8 wt %; no greater than 4.6 wt %; no greater than 4.5 wt %; no greater than 4.4 wt %; no greater than 4.3 wt %; no greater than 4.2 wt %; no greater than 4.1 wt %; no greater than 4.0 wt %; no greater than 3.5 wt %; no greater than 3.0 wt %; no greater than 2.5 wt %; no greater than 2.0 wt %; no greater than 1.5 wt %; no greater than 1.0 wt %; no greater than 0.9 wt %; no greater than 0.8 wt %; no greater than 0.7 wt %; no greater than 0.6 wt %; no greater than 0.5 wt %; no greater than 0.4 wt %; no greater than 0.3 wt %; no greater than 0.2 wt %; no greater than 0.1 wt %; no greater than 0.05 wt %; no greater than 0.01 wt %; no greater than 0.005 wt %; or no greater than 0.001 wt %. In various instances, the second solution may comprise polymer at no less than 0.001 wt %; no less than 0.005 wt %; no less than 0.01 wt %; no less than 0.05 wt %; no less than 0.1 wt %; no less than 0.2 wt %; no less than 0.3 wt %; no less than 0.4 wt %; no less than 0.5 wt %; no less than 0.6 wt %; no less than 0.7 wt %; no less than 0.8 wt %; no less than 0.9 wt %; no less than 1.0 wt %; no less than 1.5 wt %; no less than 2.0 wt %; no less than 2.5 wt %; no less than 3.0 wt %; no less than 3.5 wt %; no less than 4.0 wt %; no less than 4.1 wt %; no less than 4.2 wt %; no less than 4.3 wt %; no less than 4.4 wt %; no less than 4.5 wt %; no less than 4.6 wt %; no less than 4.7 wt %; no less than 4.8 wt %; no less than 4.9 wt %; no less than 4.95 wt %; no less than 4.99 wt %; or no less than 5.0 wt %.

### 3. Exemplary Simultaneous Electrospraying Operations

In other instances, to deposit filler particles and polymer simultaneously, exemplary electrospraying cycles may comprise electrospraying a mixed solution onto a surface of a substrate (as shown in FIG. 3).

Exemplary mixed solutions may comprise a solvent, filler particles, and a polymer. Suitable solvents for exemplary mixed solutions include, without limitation, water, methanol, ethanol, propanol, butanol, isopropanol, ethyl acetate, diethyl ether, acetone, chloroform, acetic acid, cyclohexane, hexane, toluene, N-methyl-2 pyrrolidinone, tetrahydrofuran, triethyl amine, trimethyl amine, dimethyl sulfoxide, dimethyl formamide, and combinations thereof.

In various instances, the first solution may comprise 1 wt % to 20 wt % filler particles. In various instances, the mixed solution may comprise filler particles at 1 wt % to 19 wt %; 2 wt % to 18 wt %; 3 wt % to 17 wt %; 4 wt % to 16 wt %; 5 wt % to 15 wt %; 6 wt % to 14 wt %; 7 wt % to 13 wt %; 8 wt % to 12 wt %; or 9 wt % to 11 wt %. In various instances, the mixed solution may comprise filler particles at no greater than 20 wt %; no greater than 19 wt %; no greater than 18 wt %; no greater than 17 wt %; no greater than 16 wt %; no greater than 15 wt %; no greater than 14 wt %; no greater than 13 wt %; no greater than 12 wt %; no greater than 11 wt %; no greater than 10 wt %; no greater than 9 wt %; no greater than 8 wt %; no greater than 7 wt %; no greater than 6 wt %; no greater than 5 wt %; no greater than 4 wt %; no greater than 3 wt %; no greater than 2 wt %; or no greater than 1 wt %. In various instances, the mixed solution may comprise filler particles at no less than 1 wt %; no less than 2 wt %; no less than 3 wt %; no less than 4 wt %; no less than 5 wt %; no less than 6 wt %; no less than 7 wt %; no less than 8 wt %; no less than 9 wt %; no less than 10 wt %; no less than 11 wt %; no less than 12 wt %; no less than 13 wt %; no less than 14 wt %; no less than 15 wt %; no less than 16 wt %; no less than 17 wt %; no less than 18 wt %; no less than 19 wt %; or no less than 20 wt %.

### C. Exemplary Post-Electrospraying Operations

Exemplary methods may further comprise, after electrospraying a predetermined number of cycles, removing the substrate from a support surface. After electrospraying and removing the substrate from the support surface, exemplary methods may further comprise drying the thin-film composite membrane at a suitable temperature for a suitable time period. Drying may comprise blowing air and/or placing the thin-film composite membrane in a hot air circulating chamber.

In various instances, exemplary methods may comprise drying the thin-film composite membranes at a temperature of 20° C. to 60° C. In various instances, exemplary thin-film composite membranes may be dried at a temperature of 25° C. to 55° C.; 30° C. to 50° C.; or 35° C. to 45° C. In various instances, exemplary thin-film composite membranes may be dried at a temperature of no greater than 60° C.; no greater than 55° C.; no greater than 50° C.; no greater than 45° C.; no greater than 40° C.; no greater than 35° C.; no greater than 30° C.; no greater than 25° C.; or no greater than 20° C. In various instances, exemplary thin-film composite membranes may be dried at a temperature of no less than 20° C.; no less than 25° C.; no less than 30° C.; no less than 35° C.; no less than 40° C.; no less than 45° C.; no less than 50° C.; no less than 55° C.; or no less than 60° C.

In various instances, exemplary thin-film composite membranes may be dried for a time period of 1 minute to 60 minutes. In various instances, exemplary thin-film composite membranes may be dried for a time period of 5 minutes to 55 minutes; 10 minutes to 50 minutes; 15 minutes to 45 minutes; 20 minutes to 40 minutes; or 25 minutes to 35 minutes. In various instances, exemplary thin-film composite membranes may be dried for a time period of no greater than 60 minutes; no greater than 55 minutes; no greater than 50 minutes; no greater than 45 minutes; no greater than 40 minutes; no greater than 35 minutes; no greater than 30 minutes; no greater than 25 minutes; no greater than 20 minutes; no greater than 15 minutes; no greater than 10 minutes; or no greater than 5 minutes. In various instances, exemplary thin-film composite membranes may be dried for a time period of no less than 1 minute; no less than 5 minutes; no less than 10 minutes; no less than 15 minutes; no less than 20 minutes; no less than 25 minutes; no less than 30 minutes; no less than 35 minutes; no less than 40 minutes; no less than 45 minutes; no less than 50 minutes; no less than 55 minutes; or no less than 60 minutes.

In various instances, exemplary methods may comprise curing the thin-film composite membranes at a temperature of 20° C. to 100° C. In various instances, exemplary thin-film composite membranes may be cured at a temperature of 20° C. to 90° C.; 25° C. to 85° C.; 30° C. to 80° C.; 35° C. to 75° C.; 40° C. to 70° C.; 45° C. to 65° C.; or 50° C. to 60° C. In various instances, exemplary thin-film composite membranes may be cured at a temperature of no greater than 100° C.; no greater than 90° C.; no greater than 80° C.; no greater than 70° C.; no greater than 60° C.; no greater than 50° C.; no greater than 40° C.; no greater than 30° C.; or no greater than 20° C. In various instances, exemplary thin-film composite membranes may be cured at a temperature of no less than 20° C.; no less than 30° C.; no less than 40° C.; no less than 50° C.; no less than 60° C.; no less than 70° C.; no less than 80° C.; no less than 90° C.; or no less than 100° C.

In various instances, exemplary methods may comprise curing the thin-film composite membranes for a time period of 10 minutes to 48 hours. In various instances, curing the thin-film composite membrane may occur for a time period of 15 minutes to 45 hours; 20 minutes to 40 hours; 25 minutes to 35 hours; 30 minutes to 30 hours; 35 minutes to 25 hours; 40 minutes to 20 hours; 45 minutes to 15 hours; 50 minutes to 10 hours; 1 hour to 9 hours; 2 hours to 8 hours; 3 hours to 7 hours; or 4 hours to 6 hours. In various instances, curing the thin-film composite membrane may occur for a time period of no greater than 48 hours; no greater than 45 hours; no greater than 40 hours; no greater than 35 hours; no greater than 30 hours; no greater than 25 hours; no greater than 20 hours; no greater than 15 hours; no greater than 10 hours; no greater than 9 hours; no greater than 8 hours; no greater than 7 hours; no greater than 6 hours; no greater than 5 hours; no greater than 4 hours; no greater than 3 hours; no greater than 2 hours; no greater than 1 hour; no greater than 1 hour; no greater than 55 minutes; no greater than 50 minutes; no greater than 45 minutes; no greater than 40 minutes; no greater than 35 minutes; no greater than 30 minutes; no greater than 25 minutes; no greater than 20 minutes; no greater than 15 minutes; or no greater than 10 minutes. In various instances, curing the thin-film composite membrane may occur for a time period of no less than 10 minutes; no less than 15 minutes; no less than 20 minutes; no less than 25 minutes; no less than 30 minutes; no less than 35 minutes; no less than 40 minutes; no less than 45 minutes; no less than 50 minutes; no less than 55 minutes; no less than 1 hour; no less than 2 hours; no less than 3 hours; no less than 4 hours; no less than 5 hours; no less than 6 hours; no less than 7 hours; no less than 8 hours; no less than 9 hours; no less than 10 hours; no less than 15 hours; no less than 20 hours; no less than 25 hours; no less than 30 hours; no less than 35 hours; no less than 40 hours; no less than 45 hours; or no less than 48 hours.

### D. Exemplary Methods of Making Filter Units

Exemplary thin-film composite membranes may be used to manufacture filtration units. Various methods known to those of skill in the art may be used to incorporate exemplary thin-film composite membranes into a filter. Exemplary gas filters may be constructed in various ways depending on the specific gas filter and intended use for said gas filter.

### V. Exemplary Methods of Using Thin Film Composite Membranes

Exemplary thin-film composite membranes of the present disclosure may be used for various applications. For instance, exemplary thin-film composite membranes may be used for separating gases. Exemplary methods of separating gases may comprise contacting a filter unit comprising a thin-film composite membrane with a feed gas mixture. Exemplary methods also comprise obtaining one or more chemical species from an output of the filter unit.

As used herein “contacting” may refer to, among other things, feeding, flowing, passing, injecting, introducing, and/or providing a feed gas into a filter unit comprising an exemplary thin-film composite membrane. The contacting may occur at various pressures, temperatures, depending on desired feed conditions and/or reaction conditions. The pressure, temperature, and concentration at which contacting occurs may be varied and/or adjusted according to each specific application.

Exemplary feed gases may include natural gas, syngas, flue gas, etc. In some instances, the exemplary feed gas includes one or more of H₂, CO₂, CH₄, O₂, and N₂. In some instances, the exemplary feed gas includes at least CO₂ and N₂.

Upon contacting the thin-film composite membrane of the present disclosure with a gas mixture, one or more chemical species may be subsequently captured. As used herein “capturing” refers to the act of removing one or more chemical species from a gas mixture. The capturing of the one or more chemical species may depend on a number of factors, including, but not limited to, selectivity, diffusivity, permeability, solubility, operation conditions (e.g., temperature, pressure, and concentration), and membrane properties (e.g., pore size).

In some instances, and depending on the feed gas, an output from the filter unit may comprise CO₂ and/or N₂.

### VI. Experimental Examples

Without limiting the scope of the instant disclosure, various experimental examples of embodiments discussed above were prepared and the results are discussed below.

### A. Preparation and Characterization

### Example 1: Synthesis of HKUST-1 Nanoparticles

HKUST-1 nanoparticles were synthesized according to modified literature procedures. See Park et al., Nat. Mater. 6 (10): 782-789 (2007), which is incorporated by reference herein. HKUST-1 synthesis was performed using a direct mixing procedure using acetic acid as modulator. A 100 mL ethanolic solution of 1 mmol trimesic acid was mixed directly with a 100 mL solution of 2 mmol copper acetate dissolved in 90 mL water and 10 mL of acetic acid. An immediate sky-blue color of HKUST-1 nanoparticles was formed, and the suspended powder was centrifuged immediately to avoid crystal growth. HKUST-1 nanoparticles were thoroughly solvent-exchanged with ethanol, acetone, then methanol to remove unreacted starting materials and acetic acid.

### Example 2: Synthesis of PIM-1

3,3,3′,3′-Tetramethyl-1,1′-spirobisindane-5,5′,6,6′-tetrol (27.6 mmol, 9.14 g) and 2,3,5,6-tetra-fluorophthalonitrile (27.6 mmol, 5.3 g) were dissolved in anhydrous dimethylformamide (DMF) (250 mL). Potassium carbonate (K₂CO₃) was added in the solution and the reaction was stirred at 58° C. for 40 hours. Water (400 mL) was added after cooling the reaction mixture and the product was separated by filtration. Further purification was performed by reprecipitation from the CHCl₃ solution with methanol (MeOH) and a bright yellow solid product was produced (11.4 g, yield 92%) after thermal activation at 120° C.

### Example 3: Preparation of 2 wt % PIM-1 Solution

A 2.0 g amount of PIM-1 was added to 98.0 g of chloroform. The solution was then sonicated until the polymer was completely soluble.

The 0.1 wt % and 0.5 wt % solutions of PIM-1 were prepared by dilution of the 2 wt % solutions with chloroform.

### Example 4: Preparation of 2 wt % PIM-1/HKUST-1 Solutions

In a glove box, 300 mg of activated MOF nanoparticles is added to the 1.7 g of PIM-1 in 98 g of chloroform and sonicated for several hours until all the MOF particles were suspended.

The 0.1 wt % and 0.5 wt % solutions of PIM-1/HKUST-1 were prepared by dilution of the 2 wt % solutions with chloroform.

### Example 5: Membrane Fabrication-Electrospray Deposition of PIM-1/HKUST-1

The membranes were fabricated following the 3D printing (electrospray) procedure reported in literature. See Chowdhury et al., 3D printed polyamide membranes for desalination, Science 361 (6403): 682-686 (2018), which is incorporated by reference herein. A schematic for the electrospray system utilized is shown in FIG. 2. A stainless-steel needle was connected to a high voltage DC power source (Gamma High Voltage Research, Ormond Beach, FL) which can generate up to 30 kV. A 30.48 cm (12-inch) diameter rotating drum was grounded to generate potential difference between the drum and the needle tip. The needle was suspended from an L-shaped arm attached to a stage. A ˜5 cm distance was kept between the needle tip and the rotating drum. The stage was mounted on a screw slider that moved horizontally (across the length of the rotating drum) using a stepper motor that is controlled by a motor controller (Velmex, Bloomfield, NY).

To print the membrane on the support, the drum was fist covered with aluminum foil and the PAN 400 support (about 7.62 cm×15.24 cm (3 in×6 in)) was then attached and wrapped around the foil-wrapped drum using tape. Part of the aluminum foil on the edges was left exposed. PIM-1 and HKUST-1 solution (0.1 wt % or 0.5 wt %) was then fed to the needle using a syringe pump at a flowrate of 20 m·h⁻¹ using flexible tubing.

Electrospraying was initiated on the exposed (not covered with PAN 400 support) aluminum foil to allow the spray to stabilize. The term “stable spray,” as used herein, refers to a cone-jet mode where the liquid is elongated into a long, fine jet of droplets which deposit onto the substrate surface. The applied voltage was about 6.8 kV. Once the spray was stabilized, the Velmex controller was activated which was programmed to begin the movement of the needle stage over 12 cm horizontally as the drum turned (at 15 rpm).

As the drum rotated, the PIM-1 and HKUST-1 solution were deposited on the PAN support. When the needle traversed the entire PAN 400 support once, that was considered “one scan” or “one cycle”. For multiple scans, the stage would come back to the original position at a speed of 5 cm·s⁻¹ and start the next scan. The number of scans were varied from 2-5. After the desired number of scans was done, the sample was removed, and the delivery line was cleaned with chloroform and dried with air.

### Example 6: Powder X-Ray Diffraction (XRD)

XRD patterns for the crystalline powder of MOF nanoparticles were recorded on a Panalytical X'Pert Pro MPD X-ray Diffractometer using Cu Kα radiation (λ=1.54 Å at 45 kV and 40 mA) at room temperature. Diffraction data were collected at a scan speed of 0.1°·min⁻¹, step size of 0.03° and a 2θ range of 5-40°.

### Example 7: Ultraviolet-Visible Spectroscopy (UV-VIS)

The UV-VIS of the MOF/polymer dispersed solutions in chloroform were collected on an Agilent 8453 UV-VIS spectrometer.

### Example 8: Gas Sorption Measurements

Adsorption measurements were conducted on the crystalline powder of HKUST-1 using a Micromeritics 3Flex surface area and gas analyzer instrument within the P/Pₒ range of 0-1.0.

### Example 9: Scanning Electron Microscope (SEM)

SEM measurements were performed to determine the quality of the fabricated membranes. The samples were prepared by fracturing the membranes in liquid nitrogen and subsequent sputter coating of palladium using a SPI Module Sputter Coater. SEM images were collected using a FEI Company Quanta 600 field-emission scanning electron microscope. SEM was used with a beam energy of 10 kV and a working distance of ˜10 mm in secondary electron mode to examine the morphology of the membranes.

### Example 10: Gas Permeation Measurements

Pure-gas permeance of the thin-film composite membranes were measured in a customized constant-pressure variable volume system. The membrane sample was first masked by a 50 μm thick copper shim using epoxy to seal the rim of the mask before being sealed inside a stainless-steel permeation membrane cell. The active membrane area for gas permeation was about 1 cm². Pure CO₂ or N₂ was introduced to the upstream side of the membrane at 1 bar while keeping the permeate side at atmospheric pressure. The trans-membrane steady-state flux was measured using a soap bubble flow meter (<0.1 cm³·min⁻¹) and a digital mass flow meter (0.1-20 cm³·min⁻¹) at the room temperature of 22° C. To exclude the interference of physical aging effect, all the membrane samples were pretreated with 24 h methanol soaking, followed by a vacuum drying at 40° C. for 3 hours prior to the measurement.

### B. Results/Discussion

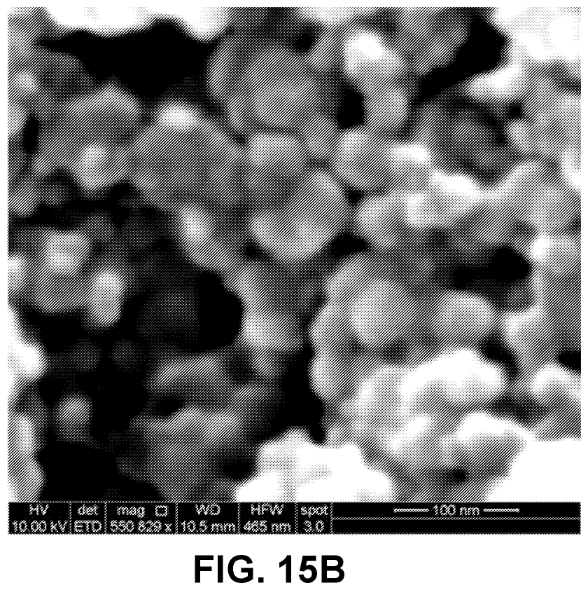

The free nitrile functional groups in the PIM-1 backbone can strongly interact with the unsaturated Cu metal centers of HKUST-1. This chemical interaction may enhance the MOF-polymer interfacial compatibility. FIG. 14 shows the ultraviolet-visible spectroscopy (UV-VIS) of a PIM-1/HKUST-1 nanoparticles solution in chloroform. A peak shift to higher energy was observed from 700 nm in HKUST-1 to 580 nm in the PIM-1/HKUST-1 mixture. This could indicate the variation in the copper (Cu) electronic environment in HKUST-1 upon the interaction with cyano groups from PIM-1 backbone.

X-ray photoelectron spectroscopy (XPS) was used to verify the HKUST-1/PIM-1 interaction. The XPS Nls spectra of PIM-1 revealed two equally intense components to the Nls spectrum at 397.7 eV and 399.7 eV from the C═N functionality of PIM-1. Upon mixing HKUST-1 with PIM-1, the unsaturated Cu centers on the surface of the HKUST-1 can coordinate with the C═N of PIM-1 resulted in a shift of the 399.7 eV component of the Nls spectrum to 397.7 eV and an increase in the relative intensity of the other component.

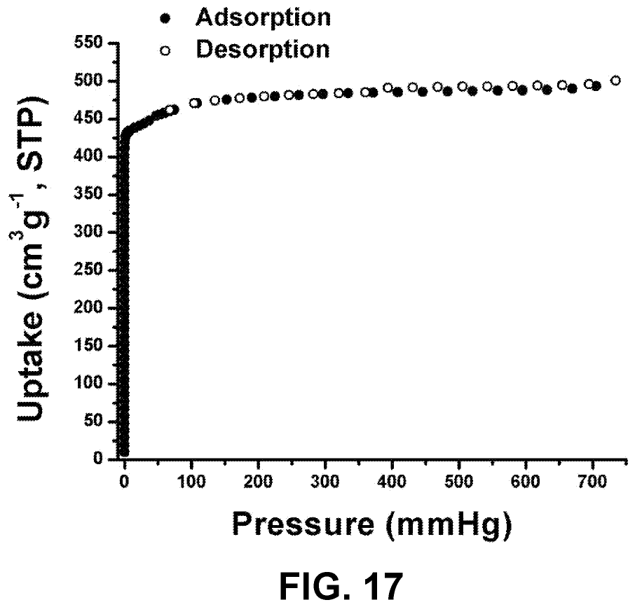

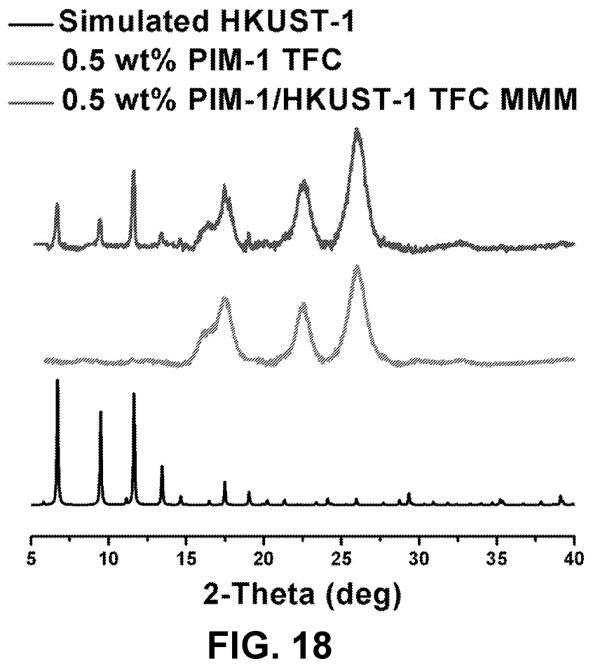

The formation of small MOF nanoparticles is highly desirable for the uniform distribution of polymer/MOF solution on the substrate. Therefore, this method was used to synthesize HKUST-1 nanoparticles in small sizes of ˜30-50 nm, as revealed by scanning electron microscopy (SEM) (FIGS. 15A-15B). The powder X-ray diffraction (PXRD) showed the high crystallinity of the HKUST-1 nanoparticles (FIG. 16), and the N₂ adsorption isotherm at 77 K revealed the retention of high porosity (BET surface area=1869 m²·g⁻¹, FIG. 17).

PIM-1/HKUST-1 mixture was deposited as nanoscale droplets using the electrospray technique forming a thin-film composite having a mixed-matrix membrane on a substrate surface. In this technique, the liquid containing the MOF/polymer mixture (PIM-1 and HKUST-1 in chloroform) was extruded from the needle in the presence of a strong electric field. This field forced the ejected droplets to spread well with diameters below 1 μm.

The solution droplet emerging from the needle was then sprayed and deposited on the substrate. The needle moved horizontally over and across the substrate attached on a rotating drum to form a uniform coating. The drum was grounded and connected to the needle through a high-voltage DC power supply that can produce up to 30 kV. A polyacrylonitrile (PAN) microporous membrane was used as a porous substrate due to its excellent chemical stability among the commercial microporous membranes. The needle stage passed along the collector surface to ensure coverage of the entire substrate.

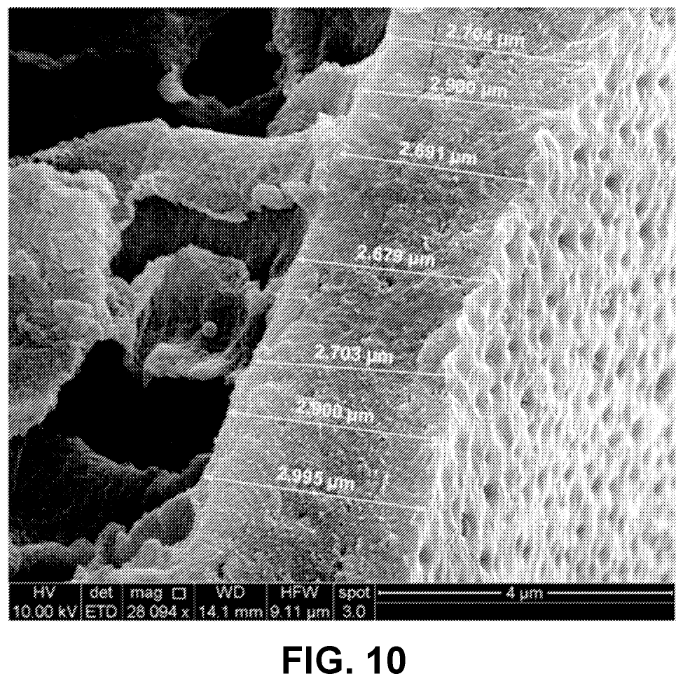

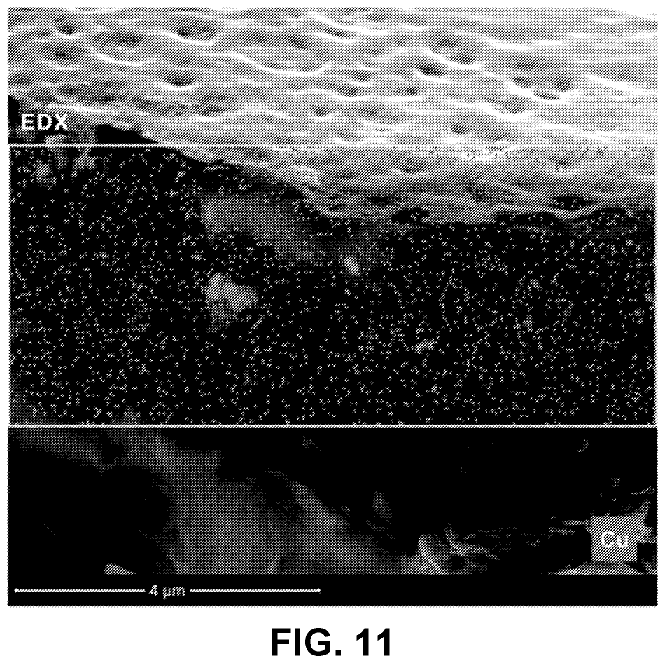

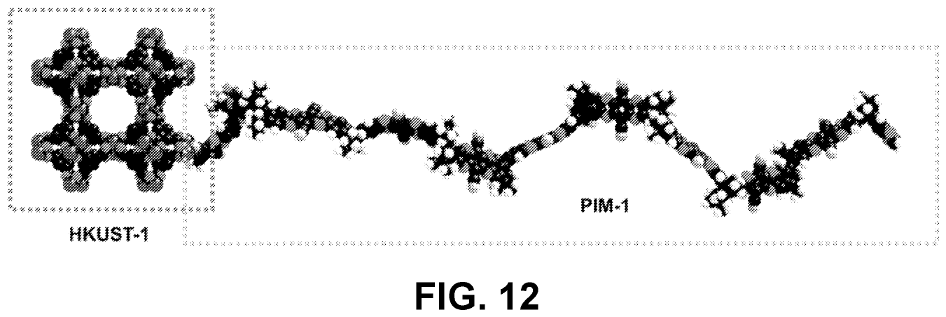

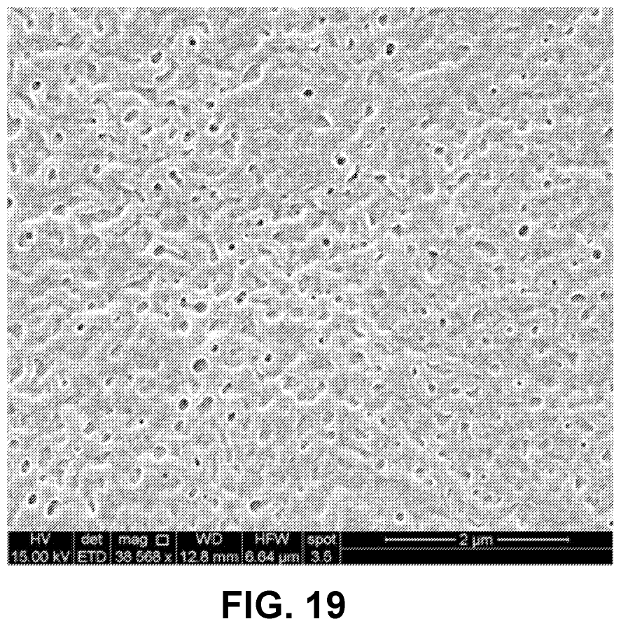

Powder diffraction (PXRD) confirmed that the MOF structures retained their crystallinity after the membrane fabrication (FIG. 18). The peaks of the PAN support were observed in both the PIM-1 and PIM-1/HKUST-1 thin-film composites. The SEM images revealed the successful fabrication of the thin-film composite membranes (FIGS. 8-11). The membrane thickness of the neat polymer or the thin-film composite mixed-matrix membrane-1 using a low concentration (0.1 wt %) of PIM-1 or PIM-1/HKUST-1 was around 400-500 nm. In comparison, the higher concentration solution (0.5 wt %) led to thicker PIM-1 and thin-film composite mixed-matrix membrane (2 layers having thicknesses of 2.5-3 μm).

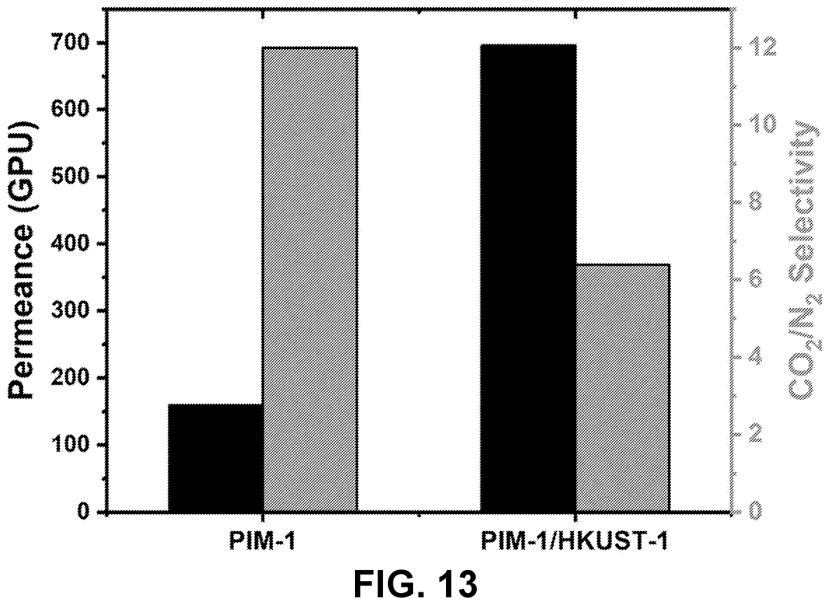

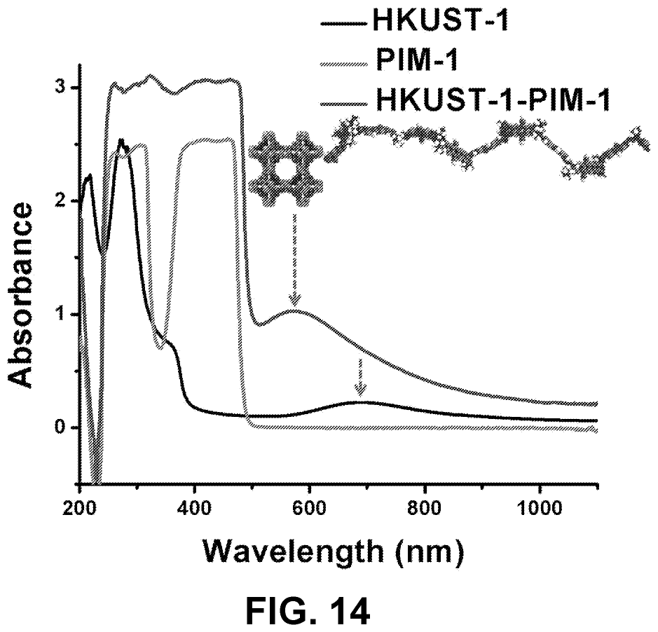

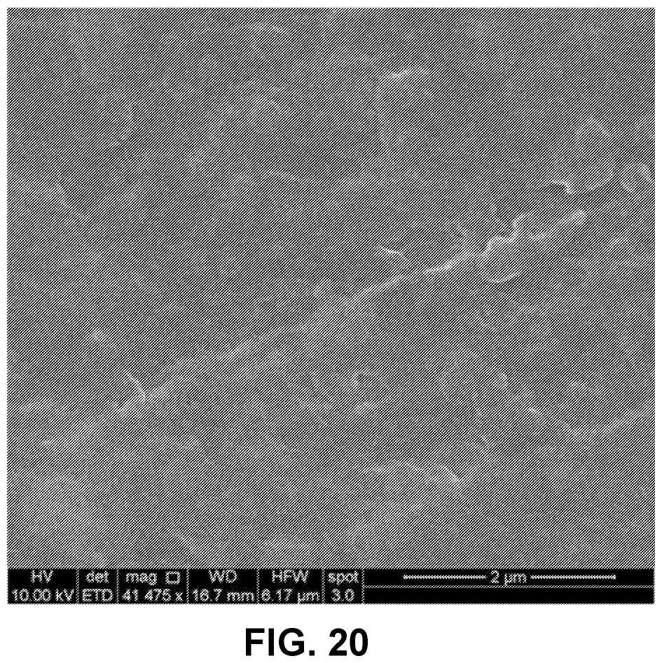

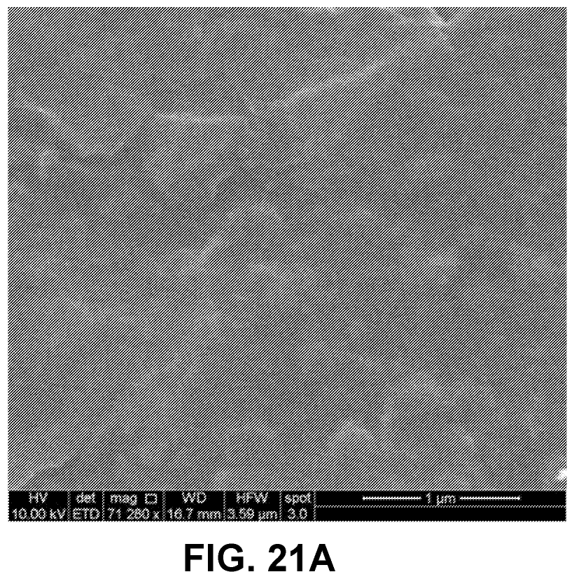

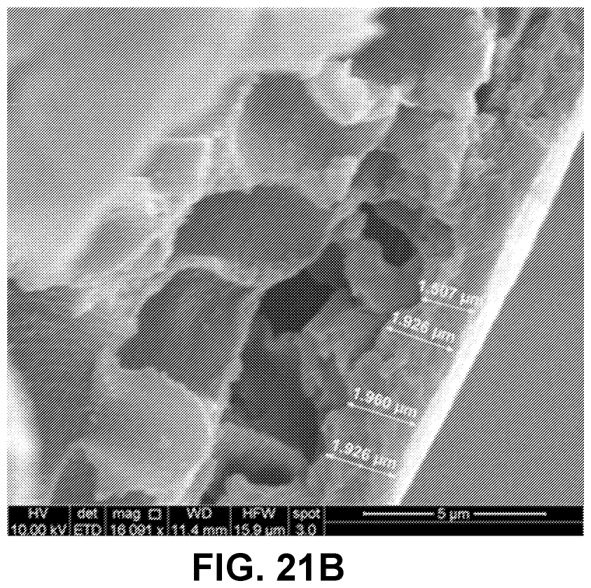

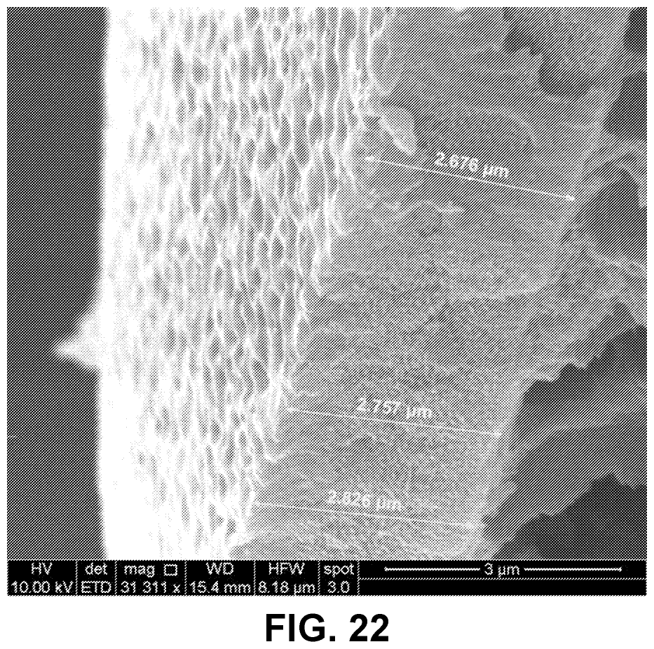

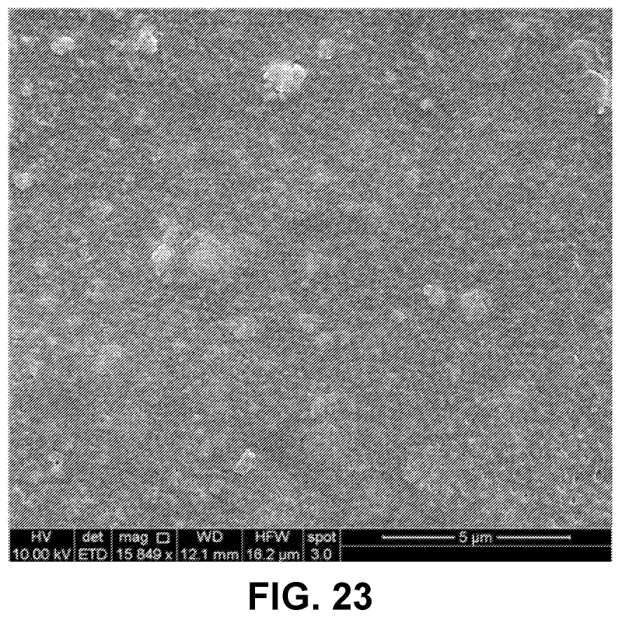

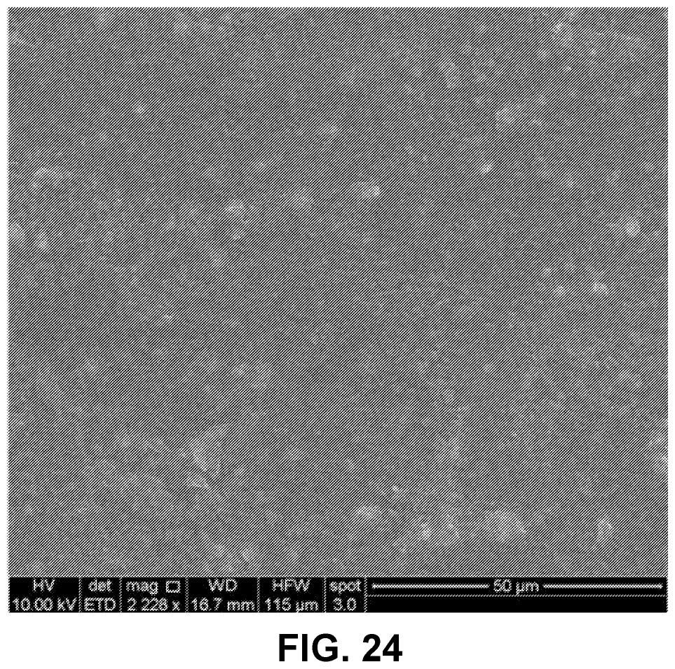

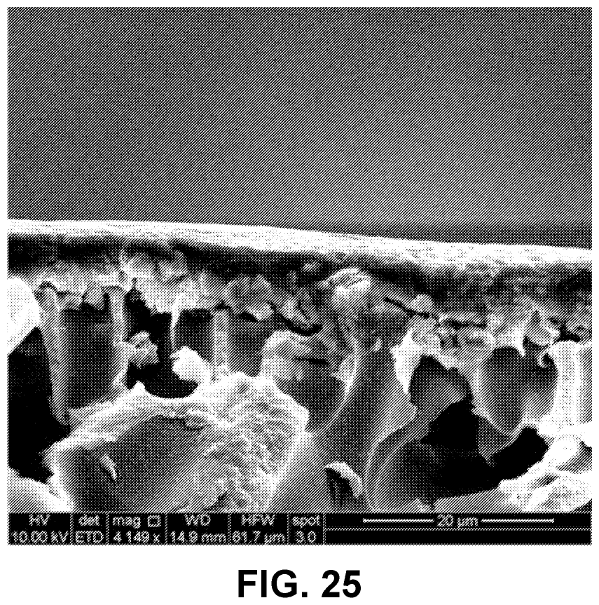

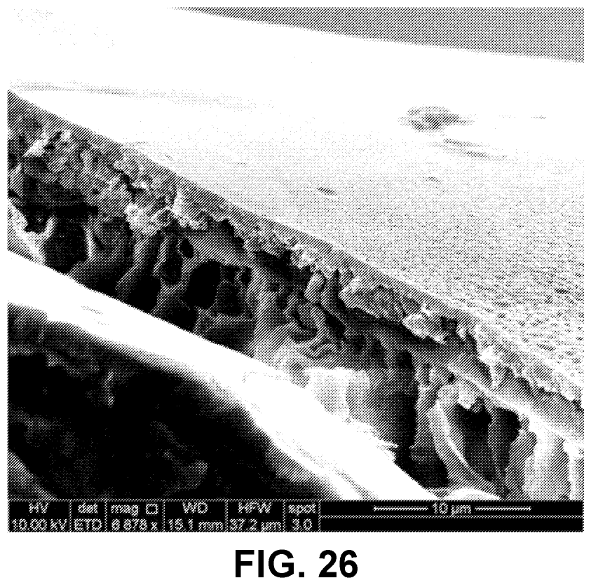

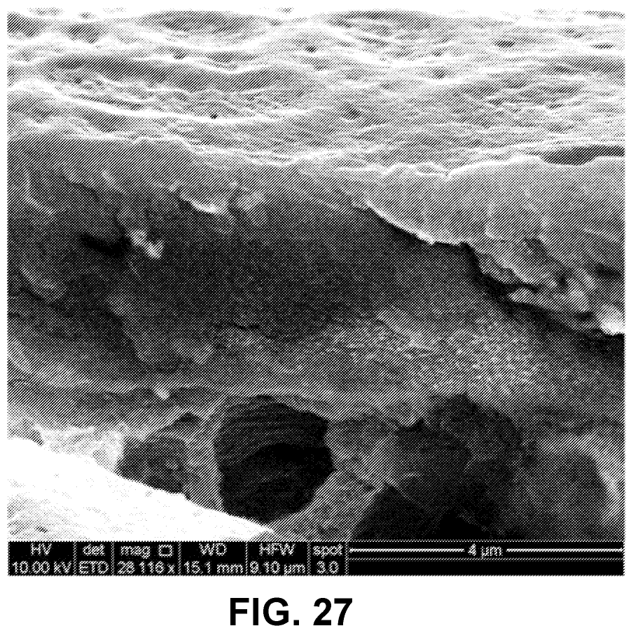

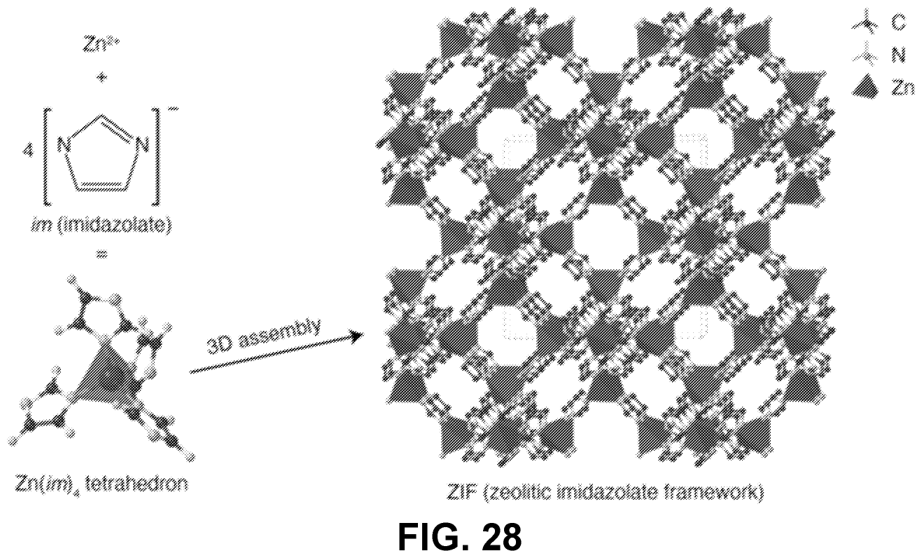

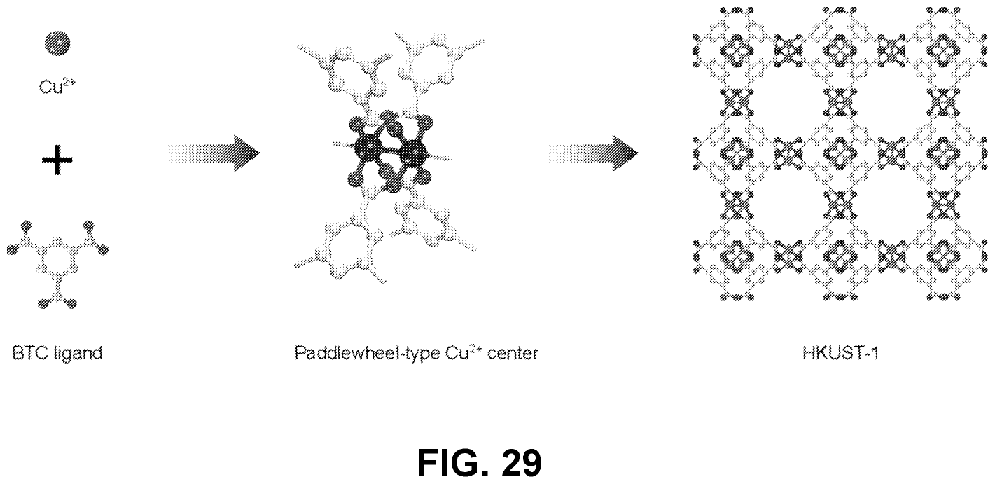

As shown in FIGS. 19-20, for thin-film composite comprising PIM-1 prepared by low concentration of PIM-1 (0.1 wt %), microscopic defects were only observed in the surface of the membrane. Therefore, the concentration was increased for the casting solution (PIM-1 and PIM-1/HKUST-1) from 0.1 wt % to 0.5 wt %. SEM cross-sectional and surface images of the fabricated thin-film composite membranes at high concentration of 0.5 wt % did not reveal any noticeable defects (FIGS. 19-27). The energy-dispersive X-ray spectroscopy (EDX) revealed that MOF nanoparticles (Cu in HKUST-1) were distributed uniformly throughout the membrane cross-section with no visible defects or large-scale phase separation (FIG. 11).

As a proof-of-concept demonstration for gas separation applications, these membranes were tested for CO₂ separation from flue gas. The gas permeation data revealed that the membranes prepared using a low concentration (0.1 wt %) of the PIM-1 or PIM-1/HKUST-1 mixture with the membrane thickness below 500 nm showed decreased CO₂/N₂ selectivity.

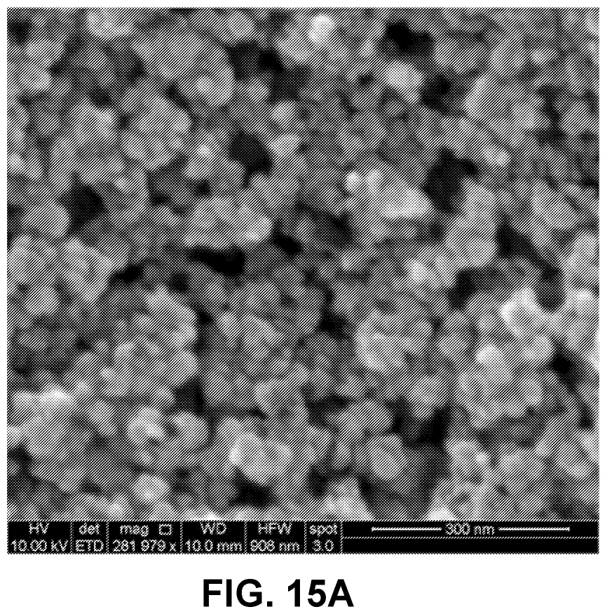

After increasing the concentration of the PIM-1 to 0.5 wt %, the membrane selectivity of the neat polymer is dramatically enhanced from 2.6 to 12 for 5 coating cycles. The same behavior was observed in the thin-film composite mixed-matrix membrane by increasing the PIM-1/HKUST-1 concentration to 0.5 wt % and membrane thickness to 2-3 μm, the CO₂/N₂ selectivity was increased from 2 to 6.4 (Tables 1 and 2; FIG. 13). Although the CO₂/N₂ selectivity of the HKUST-1/PIM-1 thin-film composite mixed-matrix membrane is decreased compared to the neat polymer, the thin-film composite mixed-matrix membrane B #2 showed four times higher CO₂ permeance than the neat PIM-1 B #1 membrane.

TABLE 1
Summary of the gas transport properties at 22°
C. of the 3D printed thin-film composite membranes
(LC for low concentration and HC for high concentration)

| | | Weight | CO₂ | |
|---|---|---|---|---|
| | Thickness | Percent | Permeance | CO₂/N₂ |
| Membrane | (μm) | (wt %) | (GPU) | Selectivity |
| PIM-1 (LC) | 0.39 | 0.1 | 147 | 2.6 |
| thin-film composite | 0.5 | 0.1 | 305 | 2 |
| mixed-matrix | | | | |
| membrane -1 | | | | |
| PIM-1 (HC) | 2.75 | 0.5 | 159 | 12 |
| thin-film composite | 2.75 | 0.5 | 696 | 6.4 |
| mixed-matrix | | | | |
| membrane -2 | | | | |

TABLE 2
Summary of the gas transport properties of the 3D printed thin-film
composite membranes (B# denotes to the batch number).

| | | | | CO₂ | N₂ | |
|---|---|---|---|---|---|---|
| | Thickness | | # of | Permeance | Permeance | CO₂/N₂ |
| Sample | (μm) | wt % | cycles | (GPU) | (GPU) | Selectivity |
| PIM-1 | 0.39 | 0.1 | 5 | 147 | 57 | 2.6 |
| PIM-1/ HKUST-1 | 0.5 | 0.1 | 5 | 305 | 153 | 2 |
| PIM-1 (B#1) | 1.8 | 0.5 | 2 | 271 | 21 | 13 |
| PIM-1 (B#2) | 2.75 | 0.5 | 5 | 159 | 13 | 12 |
| PIM-1/ HKUST-1 | 2.85 | 0.5 | 5 | 721 | 103 | 7.0 |
| (B#1) | | | | | | |
| PIM-1/ HKUST-1 | 2.85 | 0.5 | 5 | 638 | 116 | 5.5 |
| (B#2) | | | | | | |
| PIM1-HKUST-1 | 2.65 | 0.5 | 5 | 730 | 107 | 6.8 |
| (B#3) | | | | | | |

The impact of the number of coverage cycles on membrane performance was also examined. Using a high concentration of PIM-1, the thin-film composite membrane fabricated using two coverage cycles (PIM-1 B #1) showed comparable permeability and selectivity to the one with five cycles (PIM-1 B #2), which indicates a full coverage of the substrate and formation of membranes without significant defects in both cases. Also, as would be expected, the membrane permeance scales with inverse proportion to selective layer thickness, with more cycles leading to greater thickness.

In summary, MOF-based thin-film composite-mixed-matrix membrane were successfully fabricated by incorporating HKUST-1 nanoparticles into a PIM-1 matrix via a 3D electrospray printing technique. The membrane thickness was reduced to maximize the gas permeance while still ensuring that the fabricated membranes are defect-free and sufficiently robust. The thinner membranes (<500 nm) showed a lower CO₂/N₂ selectivity. However, by increasing the concentration of the membrane compositions to 0.5 wt %, 2-3 μm continuous thin-film composite membranes were fabricated and facilitated by the high control of the electrospray 3D printing technique. The 2-3 μm thick thin-film composite membranes showed improvement in CO₂/N₂ selectivity compared to the thinner membranes. Although thin-film composite mixed-matrix membrane had reduced CO₂/N₂ selectivity, the mixed-matrix membrane exhibited higher CO₂ permeance than the neat polymer.

For reasons of completeness, various aspects of the technology are set out in the following numbered embodiments:

Embodiment 1. A thin-film composite membrane, the membrane comprising:

a mixed-matrix membrane supported by a substrate, the mixed-matrix membrane comprising

two or more sublayers, wherein at least one of the sublayers comprises:
10 by weight (wt %) to 75 wt % filler particles; and
25 wt % to 90 wt % polymer.
   Embodiment 2. The thin-film composite membrane of embodiment 1, wherein the mixed-matrix membrane has a thickness of 10 nm to 1000 nm.
   Embodiment 3. The thin-film composite membrane of embodiment 1 or 2, wherein the filler particles comprise metal organic framework particles, covalent organic framework particles, zeolite particles, nanotube particles, 2D material particles, silica particles, and/or polyhedral oligomeric silsesquioxane particles.
   Embodiment 4. The thin-film composite membrane of any one of embodiments 1-3, wherein the metal organic framework particles comprise a zeolitic imidazolate framework, Cu₃(1,3,5-benzenetricarboxylate)₂, or a combination thereof.
   Embodiment 5. The thin-film composite membrane of any one of embodiments 1-4, wherein the filler particles have an average diameter of 3 nm to 100 nm.
   Embodiment 6. The thin-film composite membrane of any one of embodiments 1-5, wherein the filler particles have an average diameter of 20 nm to 80 nm.
   Embodiment 7. The thin-film composite membrane of any one of embodiments 1-6, wherein the polymer comprises polyamide, polyether, polyimide, polysulfone, cellulose acetate, a thermally rearranged polymer, a ladder polymer, or a combination thereof.
   Embodiment 8. The thin-film composite membrane of any one of embodiments 1-7, wherein the polymer comprises a polyether block amide polymer or a ladder polymer, wherein the ladder polymer is a polymer of intrinsic microporosity (PIM).
   Embodiment 9. The thin-film composite membrane of any one of embodiments 1-8, wherein the thin-film composite membrane has a CO₂ permeance between 100 GPU and 2000 GPU.
   Embodiment 10. The thin-film composite membrane of any one of embodiments 1-9, wherein the thin-film composite membrane has a CO₂/N₂ selectivity between 2 and 50.
   Embodiment 11. The thin-film composite membrane of any one of embodiments 1-10, wherein the substrate is a porous substrate.
   Embodiment 12. The thin-film composite membrane of any one of embodiments 1-11, wherein the porous substrate comprises polyacrylonitrile.
   Embodiment 13. The thin-film composite membrane of any one of embodiments 1-12, wherein the substrate has a thickness of 20 μm to 200 μm.
   Embodiment 14. A filter unit, the filter unit comprising the thin-film composite membrane of any one of embodiments 1-13.
   Embodiment 15. A method of making a thin-film composite membrane, the method comprising:

performing an electrospraying cycle, the electrospraying cycle comprising:
electrospraying a first solution onto a surface of a substrate, the solution comprising a first solvent and filler particles, the substrate being positioned on a support surface;
electrospraying a second solution onto the surface of the substrate, the second solution comprising a second solvent and a polymer; and
after electrospraying a predetermined number of cycles, removing the substrate from the support surface.
   Embodiment 16. The method of embodiment 15, further comprising rotating the substrate on a rotatable cylinder support surface while electrospraying the first and second solutions.
   Embodiment 17. The method of embodiment 15 or 16, further comprising electrospraying the first solution from a first nozzle and electrospraying the second solution from a second nozzle.
   Embodiment 18. The method of any one of embodiments 15-17, wherein the first and second nozzles move horizontally across the substrate.
   Embodiment 19. The method of any one of embodiments 15-18, wherein the first solution comprises 1 wt % to 20 wt % filler particles.
   Embodiment 20. The method of any one of embodiments 15-19, wherein the second solution comprises 0.001 wt % to 5 wt % polymer.
   Embodiment 21. The method of any one of embodiments 15-20, wherein the method comprises 2 to 50 electrospraying cycles thereby forming 2 to 50 membrane layers.
   Embodiment 22. A method of making a thin-film composite membrane, the method comprising:

performing an electrospraying cycle, the electrospraying cycle comprising:

electrospraying a mixed solution onto a surface of a substrate, the mixed solution comprising a solvent, filler particles, and a polymer, the substrate being positioned on a support surface; and

after electrospraying a predetermined number of cycles, removing the substrate from a support surface.

Embodiment 23. The method of embodiment 22, further comprising rotating the substrate on a rotatable cylinder support surface while electrospraying the mixed solution.
Embodiment 24. The method of embodiment 22 or 23, further comprising electrospraying the mixed solution from a nozzle, wherein the nozzle moves horizontally across the substrate.
Embodiment 25. The method of any one of embodiments 22-24, further comprising electrospraying the mixed solution as a stable spray from the nozzle, wherein the flow rate of the solution through the nozzle is 0.1 mL/hour to 20 mL/hour.
Embodiment 26. The method of any one of embodiments 22-25, wherein the mixed solution comprises 1 wt % to 20 wt % filler particles.
Embodiment 27. The method of any one of embodiments 22-26, wherein the method comprises 2 to 50 electrospraying cycles thereby forming 2 to 50 membrane layers.
Embodiment 28. A method of manufacturing a gas filter, the method comprising the method of any one of embodiments 15-27.
Embodiment 29. A method of using the membrane of embodiment 1 for separating gases, the method comprising:

contacting the membrane of embodiment 1 with a feed gas mixture, wherein the feed gas mixture comprises CO₂; and

capturing CO₂.

Embodiment 30. The method of embodiment 29, wherein the feed gas mixture is flue gas.

1. A thin-film composite membrane, the membrane comprising:
a mixed-matrix membrane supported by a substrate, the mixed-matrix membrane comprising
two or more sublayers, wherein at least one of the sublayers comprises:
10 by weight (wt %) to 75 wt % filler particles; and
25 wt % to 90 wt % polymer.

2. The thin-film composite membrane of claim 1, wherein the mixed-matrix membrane has a thickness of 20 nm to 1000 nm.

3. The thin-film composite membrane of claim 1, wherein the filler particles comprise metal organic framework particles, covalent organic framework particles, zeolite particles, nanotube particles, 2D material particles, silica particles, and/or polyhedral oligomeric silsesquioxane particles.

4. The thin-film composite membrane of claim 3, wherein the metal organic framework particles comprise a zeolitic imidazolate framework, Cu₃(1,3,5-benzenetricarboxylate)₂, or a combination thereof.

5. The thin-film composite membrane of claim 3, wherein the filler particles have an average diameter of 30 nm to 50 nm.

6. The thin-film composite membrane of claim 1, further comprising a sealing layer having a thickness of 5 nm to 50 nm and comprising polydimethylsiloxane (PDMS).

7. The thin-film composite membrane of claim 1, wherein the polymer comprises polyamide, polyether, polyimide, polysulfone, cellulose acetate, a thermally rearranged polymer, a ladder polymer, or a combination thereof.

8. The thin-film composite membrane of claim 1, wherein the polymer comprises a polyether block amide polymer or a ladder polymer, wherein the ladder polymer is a polymer of intrinsic microporosity (PIM).

9. The thin-film composite membrane of claim 1, wherein the thin-film composite membrane has a CO₂ permeance between 100 GPU and 2000 GPU.

10. The thin-film composite membrane of claim 1, wherein the thin-film composite membrane has a CO₂/N₂ selectivity between 2 and 50.

11. The thin-film composite membrane of claim 1, wherein the substrate is a porous substrate.

12. The thin-film composite membrane of claim 11, wherein the porous substrate comprises polyacrylonitrile.

13. The thin-film composite membrane of claim 1, wherein the substrate has a thickness of 20 μm to 200 μm.

14.-30. (canceled)

31. A filter unit comprising:
an inlet configured to receive a feed gas; and
a thin-film composite membrane in fluid communication with the inlet, the thin-film composite membrane comprising a mixed-matrix membrane supported by a substrate, the mixed-matrix membrane comprising two or more sublayers, wherein at least one of the sublayers comprises 10 by weight (wt %) to 75 wt % filler particles and 25 wt % to 90 wt % polymer; and
an outlet in fluid communication with the thin-film composite membrane, wherein the outlet is configured to provide one or more chemical species.

32. The filter unit of claim 31, wherein the feed gas comprises at least one of natural gas, syngas, flue gas, H₂, CO₂, CH₄, O₂, and N₂.

33. The filter unit of claim 31, wherein the chemical species comprise CO₂ and/or N₂.

34. The filter unit of claim 31, wherein at least one of the sublayers comprises no less than 40 wt % filler particles.

35. A gas separation device comprising a filter unit, the filter unit comprising:
an inlet configured to receive a feed gas;
a thin-film composite membrane in fluid communication with the inlet, the thin-film composite membrane comprising a mixed-matrix membrane supported by a substrate, the mixed-matrix membrane comprising two or more sublayers, wherein at least one of the sublayers comprises 10 by weight (wt %) to 75 wt % filler particles and 25 wt % to 90 wt % polymer; and
an outlet in fluid communication with the thin-film composite membrane, wherein the outlet is configured to provide one or more chemical species.

36. The filter unit of claim 35, wherein the thin-film composite membrane comprises 2 to 50 sublayers; and
wherein the thin-film composite membrane is defect free or substantially defect free.

37. The gas separation device of claim 35, wherein each sublayer has a thickness of 10 nm to 90 nm; and
wherein at least one of the sublayers comprises no less than 40 wt % filler particles.
